(19) United States
(12) Patent Application Publication
(10) Pub. No.: US 2020/0036967 A1
(43) Pub. Date: Jan. 30, 2020

(54) MOTION VECTOR SELECTION AND PREDICTION IN VIDEO CODING SYSTEMS AND METHODS

(71) Applicant: REALNETWORKS, INC., Seattle, WA (US)

(72) Inventors: Chia-Yang TSAI, Taichung City (TW); Weijia ZHU, Seattle, WA (US)

(21) Appl. No.: 16/488,222

(22) PCT Filed: Feb. 24, 2017
(86) PCT No.: PCT/CN2017/074716

§ 371 Date: Aug. 22, 2019

(51) Int. Cl. H04N 19/105; H04N 19/192; H04N 19/176; H04N 19/182

(52) U.S. Cl. CPC H04N 19/105; H04N 19/182; H04N 19/176; H04N 19/192

(57) ABSTRACT

Provided herein are systems and methods for encoding an unencoded video frame of a sequence of video frames using a recursive coding block splitting schema. After a frame is divided into the maximum allowable sized regions of pixels (LCB-sized coding blocks), each LCB-sized coding block candidate (“LCBC”) may be split into smaller CBCs. This process may continue recursively until the encoder determines (1) the current CBC is appropriate for encoding (e.g. because the current CBC contains only pixels of a single value) or (2) the current CBC is the minimum size for a coding block candidate for a particular implementation, e.g. 2×2, 4×4, etc., (an “MCBC”), whichever occurs first. One of two intra-prediction techniques may then be used to assign prediction values to the pixels of the coding block: a non-squared template matching technique or a directional prediction technique.

### CROSS-REFERENCE TO RELATED APPLICATIONS

This application is a continuation in part of previously filed PCT Application No. PCT/CN2015/098329, titled Motion Vector Selection and Prediction in Video Coding Systems and Methods, filed Dec. 22, 2015, which is a continuation in part of previously filed PCT Application No. PCT/CN2015/075599, titled Motion Vector Selection and Prediction in Video Coding Systems and Methods, filed 31 Mar. 2015, the entire disclosures of which are hereby incorporated for all purposes.

### FIELD

This disclosure relates to encoding and decoding of video signals, and more particularly, to selecting predictive motion vectors for frames of a video sequence.

### BACKGROUND

The advent of digital multimedia such as digital images, speech/audio, graphics, and video have significantly improved various applications as well as opened up brand new applications due to relative ease by which it has enabled reliable storage, communication, transmission, and, search and access of content. Overall, the applications of digital multimedia have been many, encompassing a wide spectrum including entertainment, information, medicine, and security, and have benefited the society in numerous ways. Multimedia as captured by sensors such as cameras and microphones is often analog, and the process of digitization in the form of Pulse Coded Modulation (PCM) renders it digital. However, just after digitization, the amount of resulting data can be quite significant as is necessary to re-create the analog representation needed by speakers and/or TV display. Thus, efficient communication, storage or transmission of the large volume of digital multimedia content requires its compression from raw PCM form to a compressed representation. Thus, many techniques for compression of multimedia have been invented. Over the years, video compression techniques have grown very sophisticated to the point that they can often achieve high compression factors between 10 and 100 while retaining high psycho-visual quality, often similar to uncompressed digital video.

While tremendous progress has been made to date in the art and science of video compression (as exhibited by the plethora of standards bodies driven video coding standards such as MPEG-1, MPEG-2, H.263, MPEG-4 part2, MPEG-4 AVC/H.264, MPEG-4 SVC and MVC, as well as industry driven proprietary standards such as Windows Media Video, RealVideo, On2 VP, and the like), the ever increasing appetite of consumers for even higher quality, higher definition, and now 3D (stereo) video, available for access whenever, wherever, has necessitated delivery via various means such as DVD/BD, over the air broadcast, cable/satellite, wired and mobile networks, to a range of client devices such as PCs/laptops, TVs, set top boxes, gaming consoles, portable media players/devices, smartphones, and wearable computing devices, fueling the desire for even higher levels of video compression. In the standards-body-driven standards, this is evidenced by the recently started effort by ISO MPEG in High Efficiency Video coding which is expected to combine new technology contributions and technology from a number of years of exploratory work on H.265 video compression by ITU-T standards committee.

All aforementioned standards employ a general intra/interframe predictive coding framework in order to reduce spatial and temporal redundancy in the encoded bitstream. The basic concept of interframe prediction is to remove the temporal dependencies between neighboring pictures by using block matching method. At the outset of an encoding process, each frame of the unencoded video sequence is grouped into one of three categories: I-type frames, P-type frames, and B-type frames. I-type frames are intra-coded. That is, only information from the frame itself is used to encode the picture and no inter-frame motion compensation techniques are used (although intra-frame motion compensation techniques may be applied).

The other two types of frames, P-type and B-type, are encoded using inter-frame motion compensation techniques. The difference between P-picture and B-picture is the temporal direction of the reference pictures used for motion compensation. P-type pictures utilize information from previous pictures in display order, whereas B-type pictures may utilize information from both previous and future pictures in display order.

For P-type and B-type frames, each frame is then divided into blocks of pixels, represented by coefficients of each pixel's luma and chrominance components, and one or more motion vectors are obtained for each block (because B-type pictures may utilize information from both a future and a past coded frame, two motion vectors may be encoded for each block). A motion vector (MV) represents the spatial displacement from the position of the current block to the position of a similar block in another, previously encoded frame (which may be a past or future frame in display order), respectively referred to as a reference block and a reference frame. The difference between the reference block and the current block is calculated to generate a residual (also referred to as a “residual signal”). Therefore, for each block of an inter-coded frame, only the residuals and motion vectors need to be encoded rather than the entire contents of the block. By removing this kind of temporal redundancy between frames of a video sequence, the video sequence can be compressed.

To further compress the video data, after inter or intra frame prediction techniques have been applied, the coefficients of the residual signal are often transformed from the spatial domain to the frequency domain (e.g., using a discrete cosine transform (“DCT”) or a discrete sine transform (“DST”)). For naturally occurring images, such as the type of images that typically make up human perceptible video sequences, low-frequency energy is always stronger than high-frequency energy. Residual signals in the frequency domain therefore get better energy compaction than they would in spatial domain. After forward transform, the coefficients and motion vectors may be quantized and entropy encoded.

On the decoder side, inversed quantization and inversed transforms are applied to recover the spatial residual signal. These are typical transform/quantization process in all video compression standards. A reverse prediction process may then be performed in order to generate a recreated version of the original unencoded video sequence.

In past standards, the blocks used in coding were generally sixteen by sixteen pixels (referred to as macroblocks in many video coding standards). However, since the development of these standards, frame sizes have grown larger and many devices have gained the capability to display higher than “high definition” (or “HD”) frame sizes, such as 2048×1530 pixels. Thus it may be desirable to have larger blocks to efficiently encode the motion vectors for these frame size, e.g., 64×64 pixels. However, because of the corresponding increases in resolution, it also may be desirable to be able to perform motion prediction and transformation on a relatively small scale, e.g., 4×4 pixels.

As the resolution of motion prediction increases, the amount of bandwidth required to encode and transmit motion vectors increases, both per frame and accordingly across entire video sequences.

### BRIEF DESCRIPTION OF THE DRAWINGS

FIG. 1 illustrates an exemplary video encoding/decoding system according to at least one embodiment.

FIG. 2 illustrates several components of an exemplary encoding device, in accordance with at least one embodiment.

FIG. 3 illustrates several components of an exemplary decoding device, in accordance with at least one embodiment.

FIG. 4 illustrates a block diagram of an exemplary video encoder in accordance with at least one embodiment.

FIG. 5 illustrates a block diagram of an exemplary video decoder in accordance with at least one embodiment.

FIG. 6 illustrates an exemplary motion-vector-selection routine in accordance with at least one embodiment.

FIG. 7 illustrates an exemplary motion-vector-candidate-generation sub-routine in accordance with at least one embodiment.

FIG. 8 illustrates an exemplary motion-vector-recovery routine in accordance with at least one embodiment.

FIG. 9 illustrates a schematic representation of an exemplary 8×8 prediction block in accordance with at least one embodiment.

FIGS. 10A and 10B illustrate an alternative exemplary motion-vector-candidate-generation sub-routine in accordance with at least one embodiment.

FIG. 11 illustrates a schematic diagram of an exemplary recursive coding block splitting schema in accordance with at least one embodiment.

FIG. 12 illustrates an exemplary coding block indexing routine in accordance with at least one embodiment.

FIG. 13 illustrates an exemplary coding block splitting sub-routine in accordance with at least one embodiment.

FIGS. 14A-14C illustrate a schematic diagram of an application of the exemplary recursive coding block splitting schema illustrated in FIG. 11 in accordance with at least one embodiment.

FIGS. 15A and 15B illustrate schematic diagrams of two regions of pixels corresponding to portions of respective video frames in accordance with at least one embodiment.

FIG. 16 illustrates schematic diagrams of a video frame include the region of pixels shown in FIG. 15A.

FIG. 17 illustrates an exemplary rectangular coding block prediction value selection routine in accordance with at least one embodiment.

FIG. 18 illustrates an exemplary processed-region search sub-routine in accordance with at least one embodiment.

FIG. 19 illustrates an exemplary template match test sub-routine in accordance with at least one embodiment.

FIGS. 20A-20E illustrate schematic diagrams of five regions of pixels corresponding to portions of respective video frames in accordance with at least one embodiment.

FIGS. 21A and 21B illustrate schematic diagrams of a region of pixels corresponding to a portion of a video frame in accordance with at least one embodiment.

FIG. 22 illustrates an exemplary directional prediction value selection routine in accordance with at least one embodiment.

### DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file servers, computer servers, and memory storage devices. Each of these conventional distributed computing components is accessible by the processor via a communication network.

The phrases “in one embodiment,” “in at least one embodiment,” “in various embodiments,” “in some embodiments,” and the like may be used repeatedly herein. Such phrases do not necessarily refer to the same embodiment. The terms “comprising,” “having,” and “including” are synonymous, unless the context dictates otherwise. Various embodiments are described in the context of a typical “hybrid” video coding approach, as was described generally above, in that it uses inter-/intra-picture prediction and transform coding.

Reference is now made in detail to the description of the embodiments as illustrated in the drawings. While embodiments are described in connection with the drawings and related descriptions, it will be appreciated by those of ordinary skill in the art that alternate and/or equivalent implementations may be substituted for the specific embodiments shown and described, including all alternatives, modifications, and equivalents, whether or not explicitly illustrated and/or described, without departing from the scope of the present disclosure. In various alternate embodiments, additional devices, or combinations of illustrated devices, may be added to, or combined, without limiting the scope to the embodiments disclosed herein.

### Exemplary Video Encoding/Decoding System

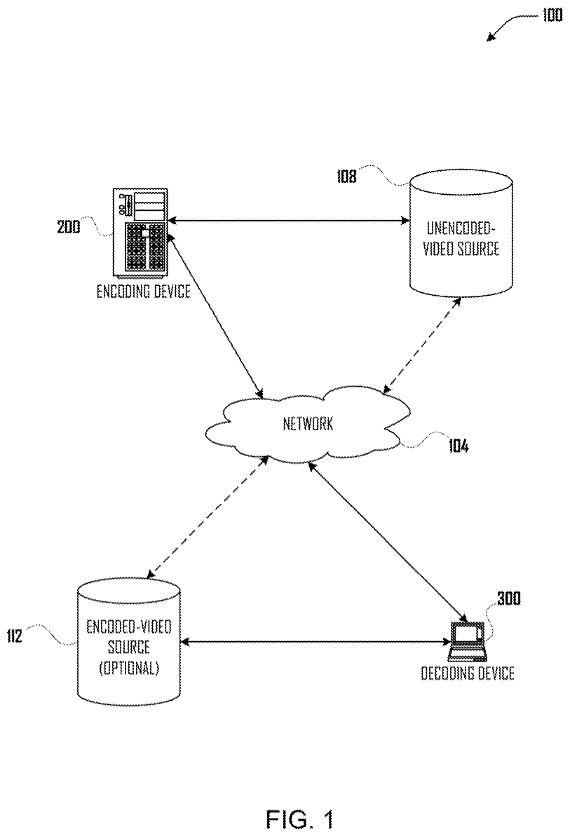

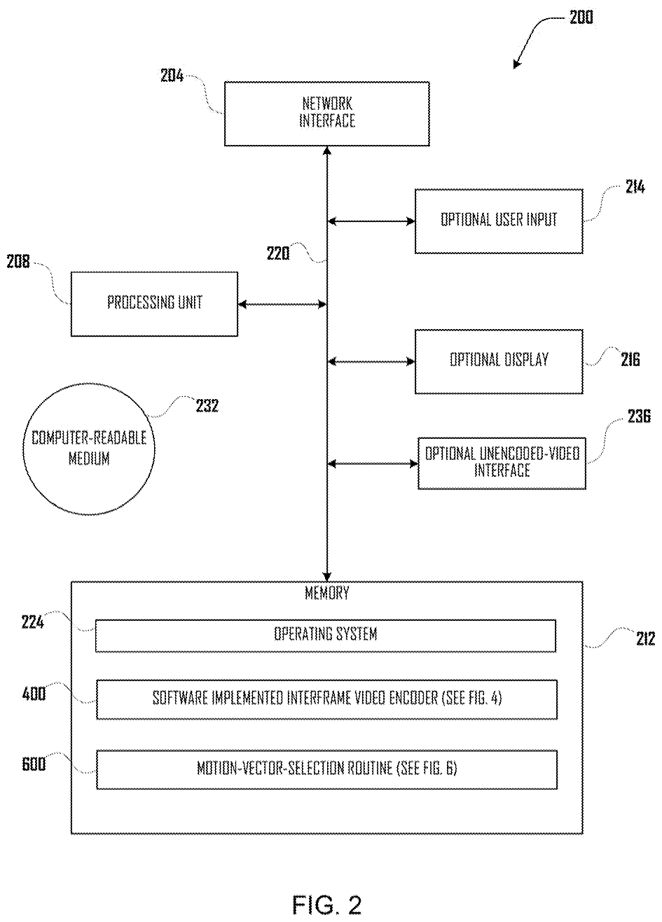

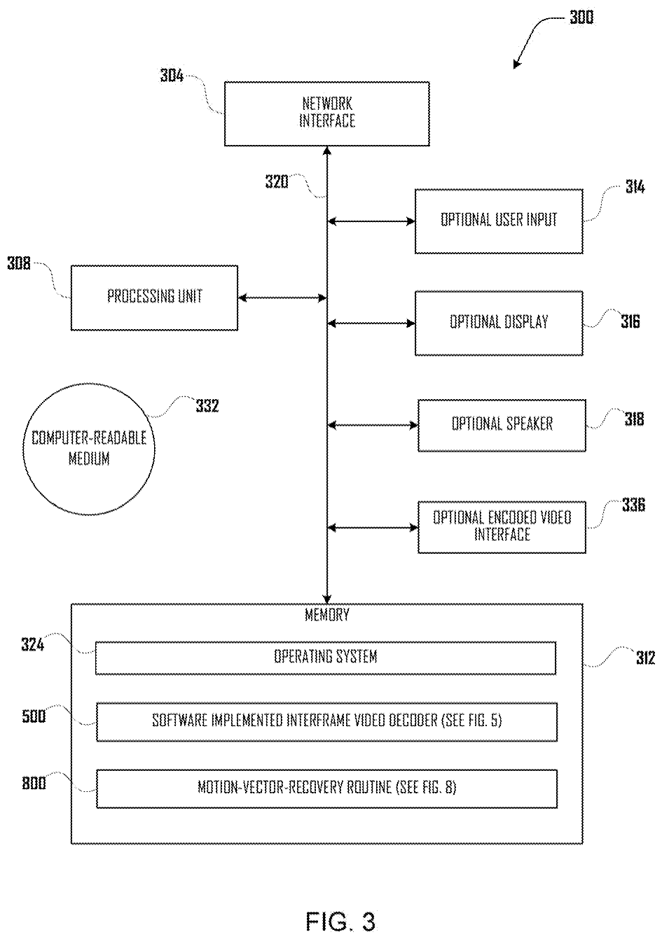

FIG. 1 illustrates an exemplary video encoding/decoding system 100 in accordance with at least one embodiment. Encoding device 200 (illustrated in FIG. 2 and described below) and decoding device 300 (illustrated in FIG. 3 and described below) are in data communication with a network 104. Decoding device 200 may be in data communication with unencoded video source 108, either through a direct data connection such as a storage area network (“SAN”), a high speed serial bus, and/or via other suitable communication technology, or via network 104 (as indicated by dashed lines in FIG. 1). Similarly, encoding device 300 may be in data communication with an optional encoded video source 112, either through a direct data connection, such as a storage area network (“SAN”), a high speed serial bus, and/or via other suitable communication technology, or via network 104 (as indicated by dashed lines in FIG. 1). In some embodiments, encoding device 200, decoding device 300, encoded-video source 112, and/or unencoded-video source 108 may comprise one or more replicated and/or distributed physical or logical devices. In many embodiments, there may be more encoding devices 200, decoding devices 300, unencoded-video sources 108, and/or encoded-video sources 112 than are illustrated.

In various embodiments, encoding device 200, may be a networked computing device generally capable of accepting requests over network 104, e.g., from decoding device 300, and providing responses accordingly. In various embodiments, decoding device 300 may be a networked computing device having a form factor such as a mobile-phone; watch, glass, or other wearable computing device; a dedicated media player; a computing tablet; a motor vehicle head unit; an audio-video on demand (AVOD) system; a dedicated media console; a gaming device, a “set-top box,” a digital video recorder, a television, or a general purpose computer. In various embodiments, network 104 may include the Internet, one or more local area networks (“LANs”), one or more wide area networks (“WANs”), cellular data networks, and/or other data networks. Network 104 may, at various points, be a wired and/or wireless network.

### Exemplary Encoding Device

Referring to FIG. 2, several components of an exemplary encoding device 200 are illustrated. In some embodiments, an encoding device may include many more components than those shown in FIG. 2. However, it is not necessary that all of these generally conventional components be shown in order to disclose an illustrative embodiment. As shown in FIG. 2, exemplary encoding device 200 includes a network interface 204 for connecting to a network, such as network 104. Exemplary encoding device 200 also includes a processing unit 208, a memory 212, an optional user input 214 (e.g., an alphanumeric keyboard, keypad, a mouse or other pointing device, a touchscreen, and/or a microphone), and an optional display 216, all interconnected along with the network interface 204 via a bus 220. The memory 212 generally comprises a RAM, a ROM, and a permanent mass storage device, such as a disk drive, flash memory, or the like.

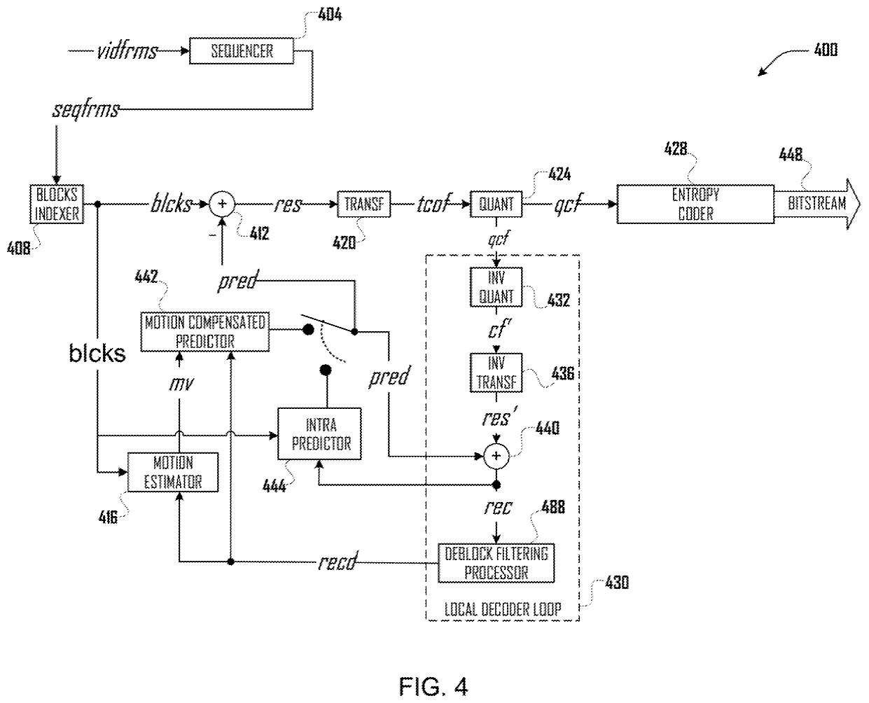

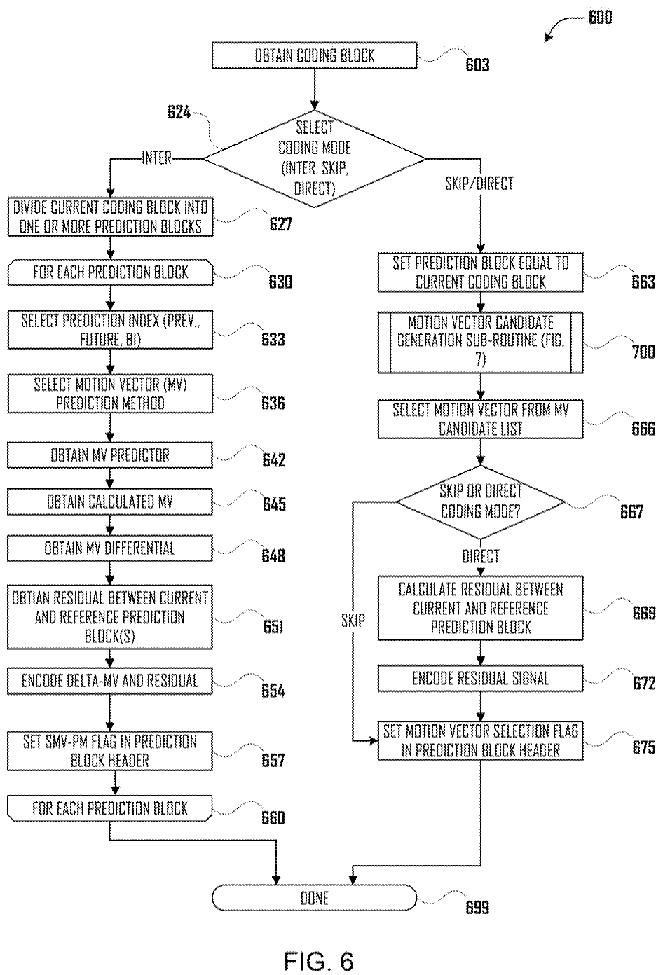

The memory 212 of exemplary encoding device 200 stores an operating system 224 as well as program code for a number of software services, such as software implemented interframe video encoder 400 (described below in reference to FIG. 4) with instructions for performing a motion-vector-selection routine 600 (described below in reference to FIG. 6). Memory 212 may also store video data files (not shown) which may represent unencoded copies of audio/visual media works, such as, by way of examples, movies and/or television episodes. These and other software components may be loaded into memory 212 of encoding device 200 using a drive mechanism (not shown) associated with a non-transitory computer-readable medium 232, such as a floppy disc, tape, DVD/CD-ROM drive, memory card, or the like. Although an exemplary encoding device 200 has been described, an encoding device may be any of a great number of networked computing devices capable of communicating with network 104 and executing instructions for implementing video encoding software, such as exemplary software implemented video encoder 400, and motion-vector-selection routine 600.

In operation, the operating system 224 manages the hardware and other software resources of the encoding device 200 and provides common services for software applications, such as software implemented interframe video encoder 400. For hardware functions such as network communications via network interface 204, receiving data via optional user input 214, outputting data via optional display 216, and allocation of memory 212 for various software applications, such as software implemented interframe video encoder 400, operating system 224 acts as an intermediary between software executing on the encoding device and the hardware.

In some embodiments, encoding device 200 may further comprise a specialized optional unencoded video interface 236 for communicating with unencoded-video source 108, such as a high speed serial bus, or the like. In some embodiments, encoding device 200 may communicate with unencoded-video source 108 via network interface 204. In other embodiments, unencoded-video source 108 may reside in memory 212 or computer readable medium 232.

Although an exemplary encoding device 200 has been described that generally conforms to conventional general purpose computing devices, an encoding device 200 may be any of a great number of devices capable of encoding video, for example, a video recording device, a video co-processor and/or accelerator, a personal computer, a game console, a set-top box, a handheld or wearable computing device, a smart phone, or any other suitable device.

Encoding device 200 may, by way of example, be operated in furtherance of an on-demand media service (not shown). In at least one exemplary embodiment, the on-demand media service may be operating encoding device 200 in furtherance of an online on-demand media store providing digital copies of media works, such as video content, to users on a per-work and/or subscription basis. The on-demand media service may obtain digital copies of such media works from unencoded video source 108.

### Exemplary Decoding Device

Referring to FIG. 3, several components of an exemplary decoding device 300 are illustrated. In some embodiments, a decoding device may include many more components than those shown in FIG. 3. However, it is not necessary that all of these generally conventional components be shown in order to disclose an illustrative embodiment. As shown in FIG. 3, exemplary decoding device 300 includes a network interface 304 for connecting to a network, such as network 104. Exemplary decoding device 300 also includes a processing unit 308, a memory 312, an optional user input 314 (e.g., an alphanumeric keyboard, keypad, a mouse or other pointing device, a touchscreen, and/or a microphone), an optional display 316, and an optional speaker 318, all interconnected along with the network interface 304 via a bus 320. The memory 312 generally comprises a RAM, a ROM, and a permanent mass storage device, such as a disk drive, flash memory, or the like.

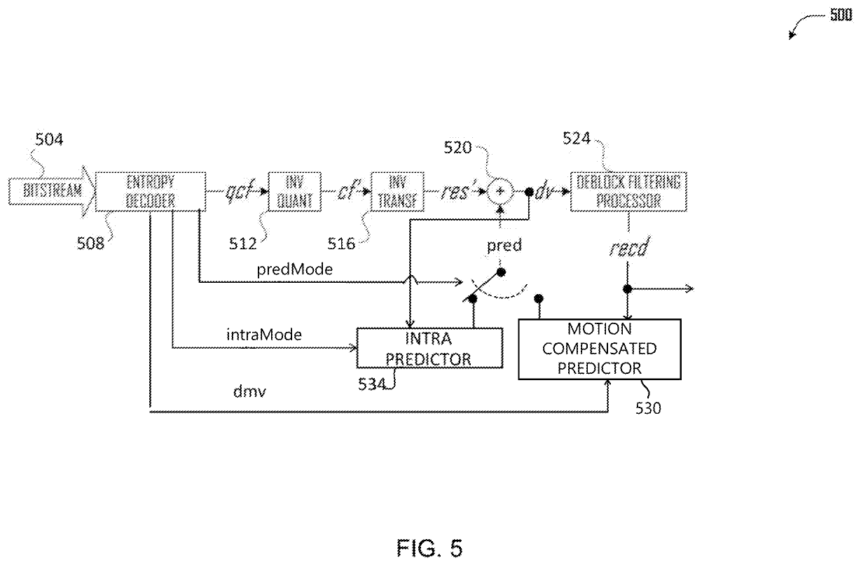

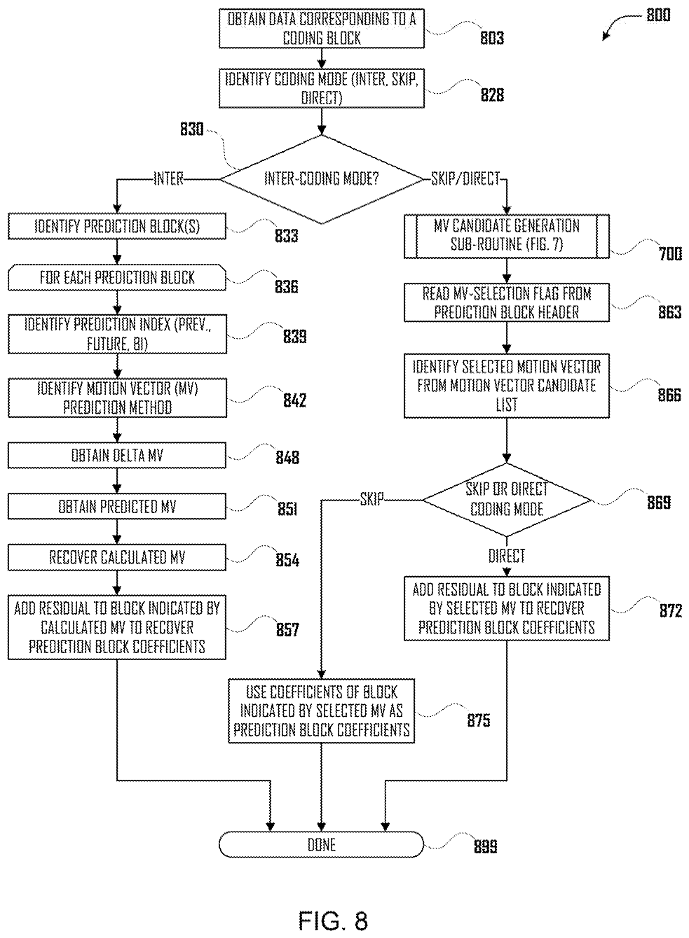

The memory 312 of exemplary decoding device 300 may store an operating system 324 as well as program code for a number of software services, such as software implemented video decoder 500 (described below in reference to FIG. 5) with instructions for performing motion-vector recovery routine 800 (described below in reference to FIG. 8). Memory 312 may also store video data files (not shown) which may represent encoded copies of audio/visual media works, such as, by way of example, movies and/or television episodes. These and other software components may be loaded into memory 312 of decoding device 300 using a drive mechanism (not shown) associated with a non-transitory computer-readable medium 332, such as a floppy disc, tape, DVD/CD-ROM drive, memory card, or the like. Although an exemplary decoding device 300 has been described, a decoding device may be any of a great number of networked computing devices capable of communicating with a network, such as network 104, and executing instructions for implementing video decoding software, such as exemplary software implemented video decoder 500, and accompanying motion-vector-recovery routine 800.

In operation, the operating system 324 manages the hardware and other software resources of the decoding device 300 and provides common services for software applications, such as software implemented video decoder 500. For hardware functions such as network communications via network interface 304, receiving data via optional user input 314, outputting data via optional display 316 and/or optional speaker 318, and allocation of memory 312, operating system 324 acts as an intermediary between software executing on the encoding device and the hardware.

In some embodiments, decoding device 300 may further comprise an optional encoded video interface 336, e.g., for communicating with encoded-video source 112, such as a high speed serial bus, or the like. In some embodiments, decoding device 300 may communicate with an encoded-video source, such as encoded video source 112, via network interface 304. In other embodiments, encoded-video source 112 may reside in memory 312 or computer readable medium 332.

Although an exemplary decoding device 300 has been described that generally conforms to conventional general purpose computing devices, an decoding device 300 may be any of a great number of devices capable of decoding video, for example, a video recording device, a video co-processor and/or accelerator, a personal computer, a game console, a set-top box, a handheld or wearable computing device, a smart phone, or any other suitable device.

Decoding device 300 may, by way of example, be operated in furtherance of the on-demand media service. In at least one exemplary embodiment, the on-demand media service may provide digital copies of media works, such as video content, to a user operating decoding device 300 on a per-work and/or subscription basis. The decoding device may obtain digital copies of such media works from unencoded video source 108 via, for example, encoding device 200 via network 104.

### Software Implemented Interframe Video Encoder

FIG. 4 shows a general functional block diagram of software implemented interframe video encoder 400 (hereafter “encoder 400”) employing residual transformation techniques in accordance with at least one embodiment. One or more unencoded video frames (vidfrms) of a video sequence in display order may be provided to sequencer 404.

Sequencer 404 may assign a predictive-coding picture-type (e.g., I, P, or B) to each unencoded video frame and reorder the sequence of frames, or groups of frames from the sequence of frames, into a coding order for motion prediction purposes (e.g., I-type frames followed by P-type frames, followed by B-type frames). The sequenced unencoded video frames (seqfrms) may then be input in coding order to blocks indexer 408.

For each of the sequenced unencoded video frames (seqfrms), blocks indexer 408 may determine a largest coding block (“LCB”) size for the current frame (e.g., sixty-four by sixty-four pixels) and divide the unencoded frame into an array of coding blocks (blcks). Individual coding blocks within a given frame may vary in size, e.g., from four by four pixels up to the LCB size for the current frame.

Each coding block may then be input one at a time to differencer 412 and may be differenced with corresponding prediction signal blocks (pred) generated from previously encoded coding blocks. To generate the prediction blocks (pred), coding blocks (blcks) are also be provided to an intra predictor 444 and a motion estimator 416. After differencing at differencer 412, a resulting residual block (res) may be forward-transformed to a frequency-domain representation by transformer 420 (discussed below), resulting in a block of transform coefficients (tcoj). The block of transform coefficients (tcoj) may then be sent to the quantizer 424 resulting in a block of quantized coefficients (qcf) that may then be sent both to an entropy coder 428 and to a local decoding loop 430.

For intra-coded coding blocks, intra predictor 444 provides a prediction signal representing a previously coded area of the same frame as the current coding block. For an inter-coded coding block, motion compensated predictor 442 provides a prediction signal representing a previously coded area of a different frame from the current coding block.

At the beginning of local decoding loop 430, inverse quantizer 432 may de-quantize the quantized coefficients (qcf) and pass the resulting de-quantized coefficients (cf) to inverse transformer 436 to generate a de-quantized residual block (res). At adder 440, a prediction block (pred) from motion compensated predictor 442 or intra predictor 444 may be added to the de-quantized residual block (res′) to generate a locally decoded block (rec). Locally decoded block (rec) may then be sent to a frame assembler and deblock filter processor 488, which reduces blockiness and assembles a recovered frame (recd), which may be used as the reference frame for motion estimator 416 and motion compensated predictor 442.

Entropy coder 428 encodes the quantized transform coefficients (qcf), differential motion vectors (dmv), and other data, generating an encoded video bit-stream 448. For each frame of the unencoded video sequence, encoded video bit-stream 448 may include encoded picture data (e.g., the encoded quantized transform coefficients (qcf) and differential motion vectors (dmv)) and an encoded frame header (e.g., syntax information such as the LCB size for the current frame).

### Inter-Coding Mode

For coding blocks being coded in the inter-coding mode, motion estimator 416 may divide each coding block into one or more prediction blocks, e.g., having sizes such as 4×4 pixels, 8×8 pixels, 16×16 pixels, 32×32 pixels, or 64×64 pixels. For example, a 64×64 coding block may be divided into sixteen 16×16 prediction blocks, four 32×32 prediction blocks, or two 32×32 prediction blocks and eight 16×16 prediction blocks. Motion estimator 416 may then calculate a motion vector (MV_{calc}) for each prediction block by identifying an appropriate reference block and determining the relative spatial displacement from the prediction block to the reference block.

In accordance with an aspect of at least one embodiment, in order to increase coding efficiency, the calculated motion vector (MV_{calc}) may be coded by subtracting a motion vector predictor (MV_{pred}) from the calculated motion vector (MV_{calc}) to obtain a motion vector differential (ΔMV). For example, if the calculated motion vector (MV_{calc}) is (5, −1) (i.e., a reference block from a previously encoded frame located five columns right and one row up relative to the current prediction block in the current frame) and the motion vector predictor is (5, 0) (i.e., a reference block from a previously encoded frame located five columns right and in the same row relative to the current prediction block in the current frame), the motion vector differential (ΔMV) will be:

MV_{calc}−MV_{pred}=(5,−1)−(5,0)=(0,−1)=ΔMV.

The closer the motion vector predictor (MVpred) is to the calculated motion vector (MVcalc), the smaller the value of the motion vector differential (ΔMV). Therefore, accurate motion vector prediction which is independent of the content of the current prediction block, making it repeatable on the decoder side, may lead to significantly less information being needed to encode motion vector differentials than the calculated motion vectors over the course of an entire video sequence.

In accordance with an aspect of at least one embodiment, motion estimator 416 may use multiple techniques to obtain a motion vector predictor (MV_{pred}). For example, the motion vector predictor may be obtained by calculating the median value of several previously encoded motion vectors for prediction blocks of the current frame. For example, the motion vector predictor may be the median value of multiple previously coded reference blocks in the spatial vicinity of the current prediction block, such as: the motion vector for the reference block (RBₐ) in the same column and one row above the current block; the motion vector for the reference block (RB_{b}) one column right and one row above the current prediction block; and the motion vector for the reference block (RB_{c}) one column to the left and in the same row as the current block.

As noted above, and in accordance with an aspect of at least one embodiment, motion estimator 416 may use additional or alternative techniques to provide a motion vector predictor for a prediction block in inter-coding mode. For example, another technique for providing a motion vector predictor may be to determine the mean value of multiple previously coded reference blocks in the spatial vicinity of the current prediction block, such as: the motion vector for the reference block (RBₐ) in the same column and one row above the current block; the motion vector for the reference block (RB_{b}) one column right and one row above the current prediction block; and the motion vector for the reference block (RB_{c}) one column to the left and in the same row as the current block.

In accordance with an aspect of at least one embodiment, in order to increase coding efficiency, the encoder 400 may indicate which of the available techniques was used in the encoding of the current prediction block by setting an selected-motion-vector-prediction-method (SMV-PM) flag in the picture header for the current frame (or the prediction block header of the current prediction block). For example, in at least one embodiment the SMV-PM flag may be a one bit variable having two possible values, wherein one possible value indicates the motion vector predictor was obtained using the median technique described above and the second possible value indicates the motion vector predictor was obtained using an alternative technique.

In coding blocks encoded in the inter-coding mode, both the motion vector and the residual may be encoded into the bit-stream.

### Skip-Coding and Direct-Coding Modes

For coding blocks being coded in the skip-coding or direct-coding modes, motion estimator 416 may use the entire coding block as the corresponding prediction block (PB).

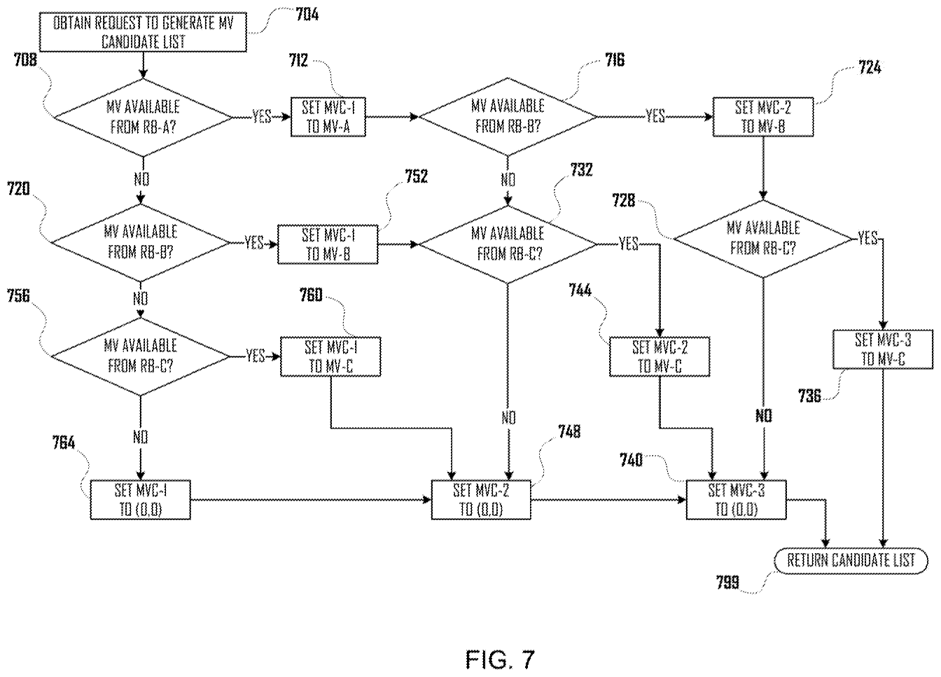

In accordance with an aspect of at least one embodiment, in the skip-coding and direct-coding modes, rather than determine a calculated motion vector (MV_{calc}) for a prediction block (PB), motion estimator 416 may use a predefined method, described below in reference to FIG. 7, to generate an ordered list of motion vector candidates. For example, for a current prediction block (PBₒᵤₜ), the ordered list of motion vector candidates may be made up of motion vectors previously used for coding other blocks of the current frame, referred to as “reference blocks” (RBs).

In accordance with an aspect of at least one embodiment, motion estimator 416 may then select the best motion vector candidate (MVC) from the ordered list for encoding the current prediction block (PB_{cur}). If the process for generating the ordered list of motion vector candidates is repeatable on the decoder side only the index of the selected motion vector (MVₛₑₜ) within the ordered list of motion vector candidates may be included in encoded bit-stream rather than a motion vector itself. Over the course of an entire video sequence significantly less information may be needed to encode the index values than actual motion vectors.

In accordance with an aspect of at least one embodiment, the motion vectors selected to populate the motion vector candidate list are preferably taken from three reference blocks (RBₐ, RB_{b}, RB_{c}) that have known motion vectors and share a border the current prediction block (PB_{cur}) and/or another reference block (RB). For example, the first reference block (RBₐ) may be located directly above the current prediction block (PB_{cur}), the second reference block (RB_{b}) may be located directly to the right of the first reference block (RBₐ), and the third reference block (RB_{c}) may be located to the left of the current prediction block (RBc). However, the specific locations of the reference blocks relative to the current prediction block may not be important, so long as they are pre-defined so a downstream decoder may know where they are.

In accordance with an aspect of at least one embodiment, if all three reference blocks have known motion vectors, the first motion vector candidate (MVC₁) in the motion vector candidate list for the current prediction block (PB_{cur}) may be the motion vector (MVₐ) (or motion vectors, in a B-type frame) from the first reference block (RBₐ), the second motion vector candidate (MVC₂) may be the motion vector (MV_{b}) (or motion vectors) from the second reference block (RB_{b}), and the third motion vector candidate (MVC) may be the motion vector (MV_{c}) (or motion vectors) from the third reference block (RB_{c}). The motion vector candidate list may therefore be: (MVa, MVb, MVc).

However, if any of the reference blocks (RBs) do not have available motion vectors, e.g., because no prediction information is available for a given reference block or the current prediction block (PB_{cur}) is in the top row, leftmost column, or rightmost column of the current frame, that motion vector candidate may be skipped and the next motion vector candidate may take its place, and zero value motion vectors (0,0) may be substituted for the remaining candidate levels. For example, if no motion vector is available for RB_{b}, the motion vector candidate list may be: (MVa, MVc, (0,0)).

The full set of combinations for a motion vector candidate list given various combinations of motion vector candidate availability, in accordance with at least one embodiment, is shown in Table 1:

TABLE 1

| RBₐ | RB_{b} | RB_{c} | MVC₁ | MVC₂ | MVC₃ |
|---|---|---|---|---|---|
| n/a | n/a | n/a | (0,0) | (0,0) | (0,0) |
| n/a | n/a | MV_{c} | MV_{c} | (0,0) | (0,0) |
| n/a | MV_{b} | N/A | MV_{b} | (0,0) | (0,0) |
| n/a | MV_{b} | MV_{c} | MV_{b} | MV_{c} | (0,0) |
| MVₐ | n/a | n/a | MVₐ | (0,0) | (0,0) |
| MVₐ | n/a | MV_{c} | MVₐ | MV_{c} | (0,0) |
| MVₐ | MV_{b} | n/a | MVₐ | MV_{b} | (0,0) |
| MVₐ | MV_{b} | MV_{c} | MVₐ | MV_{b} | MV_{c} |

Motion estimator 416 may then evaluate the motion vector candidates and select the best motion vector candidate to be used as the selected motion vector for the current prediction block. Note that as long as a downstream decoder knows how to populate the ordered list of motion vector candidates for a given prediction block, this calculation can be repeated on the decoder side with no knowledge of the contents of the current prediction block. Therefore, only the index of the selected motion vector from the motion vector candidate list needs to be included in encoded bit-stream rather than a motion vector itself, for example by setting a motion-vector-selection flag in the prediction block header of the current prediction block, and thus, over the course of an entire video sequence, significantly less information will be needed to encode the index values than actual motion vectors.

In the direct-coding mode, the motion-vector-selection flag and the residual between the current prediction block and the block of the reference frame indicated by the motion vector are encoded. In the skip-coding mode, the motion-vector-selection flag is encoded but the encoding of the residual signal is skipped. In essence, this tells a downstream decoder to use the block of the reference frame indicated by the motion vector in place of the current prediction block of the current frame.

### Software Implemented Interframe Decoder

FIG. 5 shows a general functional block diagram of a corresponding software implemented interframe video decoder 500 (hereafter “decoder 500”) inverse residual transformation techniques in accordance with at least one embodiment and being suitable for use with a decoding device, such as decoding device 300. Decoder 500 may work similarly to the local decoding loop 430 at encoder 400.

Specifically, an encoded video bit-stream 504 to be decoded may be provided to an entropy decoder 508, which may decode blocks of quantized coefficients (qcf), differential motion vectors (dmv), accompanying message data packets (msg-data), and other data, including the prediction mode (intra or inter). The quantized coefficient blocks (qcf) may then be reorganized by an inverse quantizer 512, resulting in recovered transform coefficient blocks (cf′). Recovered transform coefficient blocks (cf′) may then be inverse transformed out of the frequency-domain by an inverse transformer 516 (described below), resulting in decoded residual blocks (res). An adder 520 may add motion compensated prediction blocks (pred) obtained by using corresponding motion vectors (dmv) from a motion compensated predictor 530 or from intra predictor 534. The resulting decoded video (dv) may be deblock-filtered in a frame assembler and deblock filtering processor 524. Blocks (recd) at the output of frame assembler and deblock filtering processor 524 form a reconstructed frame of the video sequence, which may be output from the decoder 500 and also may be used as the reference frame for a motion-compensated predictor 530 for decoding subsequent coding blocks.

### Motion Vector Selection Routine

FIG. 6 illustrates a motion-vector-selection routine 600 suitable for use with at least one embodiment, such as encoder 400. As will be recognized by those having ordinary skill in the art, not all events in the encoding process are illustrated in FIG. 6. Rather, for clarity, only those steps reasonably relevant to describing the motion-vector-selection routine are shown.

At execution block 603, a coding block is obtained, e.g., by motion estimator 416.

At decision block 624, motion-vector-selection routine 600 selects a coding mode for the coding block. For example, as is described above, an inter-coding mode, a direct-coding mode, or a skip-coding mode may be selected. If either the skip-coding or the direct-coding modes are selected for the current coding block, motion-vector-selection routine 600 may proceed to execution block 663, described below.

If, at decision block 624, the inter-coding mode is selected for the current coding block, then at execution block 627 motion-vector-selection routine 600 may divide the current coding block into one or more prediction blocks and, beginning at starting loop block 630, each prediction block of the current coding block may be addressed in turn.

At execution block 633, motion-vector-selection routine 600 may select a prediction index for the current prediction block, indicating whether the reference frame is a previous picture, a future picture, or both, in the case of a B-type picture.

At execution block 636, motion-vector-selection routine 600 may then select a motion-vector prediction method, such as the median or mean techniques described above or any available alternative motion-vector prediction method.

At execution block 642, motion-vector-selection routine 600 may obtain a motion vector predictor (MV_{pred}) for the current prediction block using the selected motion vector prediction method.

At execution block 645, motion-vector-selection routine 600 may obtain a calculated motion vector (MV_{calc}) for the current prediction block.

At execution block 648, motion-vector-selection routine 600 may obtain a motion vector differential (ΔMV) for the current prediction block (note for P-type pictures there may be a single motion vector differential and for B-type pictures there may be two motion vector differentials).

At execution block 651, motion-vector-selection routine 600 may obtain a residual between the current prediction block (PB_{cur}) relative to the block indicated by the calculated motion vector (MV_{calc}).

At execution block 654, motion-vector-selection routine 600 may encode the motion vector differential(s) and the residual for the current prediction block.

At execution block 657, motion-vector-selection routine 600 may set an SMV-PM flag in the picture header for the current frame (or the prediction block header for the current prediction block) indicating which motion vector prediction technique was used for the current prediction block.

At ending loop block 660, motion-vector-selection routine 600 returns to starting loop block 630 to process the next prediction block (if any) of the current coding block.

Returning to decision block 624, if either the skip-coding or direct-coding modes is selected for the current coding block, then at execution block 663 motion-vector-selection routine 600 sets the current prediction block to equal the current coding block.

Motion-vector-selection routine 600 may then call motion-vector-candidate-generation sub-routine 700 (described below in reference to FIG. 7), which may return an ordered list of motion vector candidates to motion-vector-selection routine 600.

At execution block 666, motion-vector-selection routine 600 may then select a motion vector from the motion vector candidate list for use in coding the current prediction block.

At decision block 667, if the selected coding mode is direct-coding, then at execution block 669 motion-vector-selection routine 600 calculates a residual between the current prediction block and the reference block indicated by the selected motion vector.

At execution block 672, motion-vector-selection routine 600 may encode the residual and at execution block 675 motion-vector-selection routine 600 may set a motion-vector-selection flag in the current prediction block's prediction block header indicating which of the motion vector candidates was selected for use in coding the current prediction block.

Motion-vector-selection routine 600 ends at termination block 699.

### Motion-Vector-Candidate-Generation Sub-Routine 700

FIG. 7 depicts motion-vector-candidate-generation sub-routine 700 for generating an ordered list of motion vector candidates in accordance with at least one embodiment. In the illustrated embodiment, three motion vector candidates are generated. However, those having ordinary skill in the art will recognize that greater or fewer amounts of candidates may be generated using the same technique, and further that alternate and/or equivalent implementations may be substituted for the specific embodiments shown and described without departing from the scope of the present disclosure.

Motion-vector-candidate generation sub-routine 700 obtains a request to generate a motion-vector-candidate list for the current prediction block at execution block 704.

At decision block 708, if a motion vector is available from the first candidate reference block (RBₐ), then at execution block 712, motion-vector-candidate generation sub-routine 700 may set the first motion vector candidate (MVC₁) to MVₐ and proceed to decision block 716.

At decision block 716, if a motion vector is available from the second candidate reference block (RB_{b}), then at execution block 724, motion-vector-candidate generation sub-routine 700 may set the second motion vector candidate (MVC₂) to MV_{b} and proceed to decision block 728.

At decision block 728, if a motion vector is available from the third candidate block (RB_{c}), then at execution block 736, motion-vector-candidate generation sub-routine 700 may set the third motion vector candidate (MVC₃) to MVc.

Motion-vector-candidate generation sub-routine 700 may then return a motion vector candidate list having respective values of MVC₁=MVₐ, MVC₂=MV_{b}, and MVC₃=MV_{c} at return block 799.

Referring again to decision block 728, if no motion vector is available from the third candidate block (RB_{c}), then at execution block 740 motion-vector-candidate generation sub-routine 700 may set the third motion vector candidate (MVC₃) to (0,0).

Motion-vector-candidate generation sub-routine 700 may then return a motion vector candidate list having respective values of MVC₁=MVₐ, MVC₂=MV_{b}, and MVC₃=(0,0) at return block 799.

Referring again to decision block 716, if no motion vector is available from the second candidate block (RB_{b}), then motion-vector-candidate generation sub-routine 700 may proceed to decision block 732.

At decision block 732, if a motion vector is available from the third candidate reference block (RB_{c}), then at execution block 744 motion-vector-candidate-generation sub-routine 700 may set the second motion vector candidate (MVC₂) to MVc. The third motion vector candidate (MVC₃) may then be set to (0,0) at execution block 740.

Motion-vector-candidate generation sub-routine 700 may then return a motion vector candidate list having respective values of MVC1=MVa, MVC2=MVc, and MVC3=(0,0) at return block 799.

Referring again to decision block 732, if no motion vector is available from the third candidate reference block (RB_{c}), then at execution block 748, motion-vector-candidate-generation sub-routine 700 may set the second motion vector candidate (MVC₂) to (0,0) and may set the third motion vector candidate (MVC₃) to (0,0) at execution block 740.

Motion-vector-candidate generation sub-routine 700 may then return a motion vector candidate list having respective values of MVC₁=MVₐ, MVC₂=(0,0), and MVC₃=(0,0) at return block 799.

Referring again to decision block 708, if no motion vector is available from the first candidate reference block (RBₐ), motion-vector-candidate generation sub-routine 700 may proceed to decision block 720.

At decision block 720, if a motion vector is available from the second candidate reference block (RB_{b}), then at execution block 752 motion-vector-candidate-generation sub-routine 700 may set the first motion vector candidate (MVC₁) to MV_{b}. Motion-vector-candidate-generation sub-routine 700 may then proceed to decision block 732.

Returning again to decision block 732, if a motion vector is available from the third candidate reference block (RB_{c}), then at execution block 744 motion-vector-candidate-generation sub-routine 700 may set the second motion vector candidate (MVC₂) to MVc. The third motion vector candidate (MVC₃) may then be set to (0,0) at execution block 740.

Motion-vector-candidate generation sub-routine 700 may then return a motion vector candidate list having respective values of MVC₁=MV_{b}, MVC₂=MV, and MVC₃=(0,0) at return block 799.

Referring again to decision block 732, if no motion vector is available from the third candidate reference block (RB_{c}), then at execution block 748 motion-vector-candidate-generation sub-routine 700 may set the second motion vector candidate (MVC₂) to (0,0) and may set the third motion vector candidate (MVC₃) to (0,0) at execution block 740.

Motion-vector-candidate generation sub-routine 700 may then return a motion vector candidate list having respective values of MVC₁=MV_{b}, MVC₂=(0,0), and MVC₃=(0,0) at return block 799.

Referring again to decision block 720, if no motion vector is available from the second candidate reference block (RB_{b}), then motion-vector-candidate generation sub-routine 700 may proceed to decision block 756.

At decision block 756, if a motion vector is available from the third candidate reference block (RB_{c}), then at execution block 760 motion-vector-candidate generation sub-routine 700 may set the first motion vector candidate (MVC₁) to MVc. Motion-vector-candidate generation sub-routine 700 may then set the second motion vector candidate (MVC₂) to (0,0) at execution block 748 and the third motion vector candidate (MVC₃) to (0,0) at execution block 740.

Motion-vector-candidate generation sub-routine 700 may then return a motion vector candidate list having respective values of MVC₁=MV_{c}, MVC₂=(0,0), and MVC₃=(0,0) at return block 799.

Referring again to decision block 756, if no motion vector is available from the third candidate reference block (RB_{c}), then at execution block 764, motion-vector-candidate generation sub-routine 700 may set the first motion vector candidate (MVC₁) to (0,0). Motion-vector-candidate generation sub-routine 700 may then set the second motion vector candidate to (0,0) at execution block 748, and may set the third motion vector candidate to (0,0) at execution block 740.

Motion-vector-candidate generation sub-routine 700 may then return a motion vector candidate list having respective values of MVC₁=MV_{b}, MVC₂=(0,0), and MVC₃=(0,0) at return block 799.

### Motion-Vector-Recovery Routine 800

FIG. 8 illustrates a motion-vector-recovery routine 800 suitable for use with at least one embodiment, such as decoder 500. As will be recognized by those having ordinary skill in the art, not all events in the decoding process are illustrated in FIG. 8. Rather, for clarity, only those steps reasonably relevant to describing the motion vector selection routine are shown.

At execution block 803, motion-vector-recovery routine 800 may obtain data corresponding to a coding block.

At execution block 828, motion-vector-recovery-routine 800 may identify the coding mode used to encode the coding block. As is described above, the possible coding modes may be an inter-coding mode, a direct-coding mode, or a skip-coding mode.

At decision block 830, if the coding block was encoded using the inter-coding mode, then at execution block 833 motion-vector-recovery routine 800 may identify the corresponding prediction block(s) for the coding block. At beginning loop block 836, each prediction block of the current coding block may be addressed in turn.

At execution block 839, motion-vector-recovery routine 800 may identify the prediction index for the current prediction block from the prediction block header.

At execution block 842, motion-vector-recovery routine 800 may identify the motion vector prediction method used for predicting the motion vector for the current prediction block, for example by reading an SMV-PM flag in the picture header for the current frame.

At execution block 848, motion-vector-recovery routine 800 may obtain a motion-vector differential (ΔMV) for the current prediction block.

At execution block 851, motion-vector-recovery routine 800 may obtain a predicted motion vector (MV_{pred}) for the current prediction block using the motion vector prediction method identified in execution block 842.

At execution block 854, motion-vector-recovery routine 800 may recover the calculated motion vector (MV_{calc}) for the current prediction block (note for P-type pictures there may be a single recovered motion vector and for B-type pictures there may be two recovered motion vectors), for example by adding the predicted motion vector (MV_{pred}) to the motion vector differential (ΔMV).

At execution block 857, motion-vector-recovery routine 800 may then add the residual for the current prediction block to the block indicated by the calculated motion vector (MV_{calc}) to obtain recovered values for the prediction block.

Referring again to decision block 830, if the current coding block was encoded using either the skip-coding or direct-coding modes, then motion-vector-recovery routine 800 may then call motion-vector-candidate-generation sub-routine 700 (described above in reference to FIG. 7), which may return an ordered list of motion vector candidates to motion-vector-recovery routine 800.

At execution block 863 motion-vector-recovery routine 800 may then read the motion-vector-selection flag from the prediction block header at execution block 863.

At execution block 866, motion-vector-recovery routine 800 may then use the motion-vector-selection flag to identify the motion vector from the ordered list of motion vector candidates list that was used to encode the current prediction block.

At decision block 869, if the current coding block was encoded in the direct-coding mode, at execution block 872 motion-vector-recovery routine 800 may add the residual for the prediction block to the coefficients of the block identified by the selected motion vector to recover the prediction block coefficients.

If the current coding block was encoded in the skip-coding mode, then at execution block 875, motion-vector-recovery routine 800 may use the coefficients of the reference block indicated by the selected motion vector as the coefficients for the prediction block.

Motion-vector-recovery routine 800 ends at termination block 899.

### Alternative Motion Vector Selection Routine for Skip-Coding and Direct-Coding Modes

Referring again to FIG. 4, for coding blocks being coded in the skip-coding or direct-coding modes, motion estimator 416 may use the entire coding block as the corresponding prediction block (PB).

In accordance with an aspect of at least one embodiment, in the skip-coding and direct-coding modes, rather than determine a calculated motion vector (MV_{calc}) for a prediction block (PB), motion estimator 416 may use a predefined method to generate an ordered list of four motion vector candidates (MVCL). For example, for a current prediction block (PB_{cur}), the ordered list of motion vector candidates may be made up of motion vectors previously used for coding other blocks of the current frame, referred to as “reference blocks” (RBs) and/or zero value motion vectors.

In accordance with an aspect of at least one embodiment, motion estimator 416 may then select the best motion vector candidate (MVC) from the ordered list for encoding the current prediction block (PB_{cur}). If the process for generating the ordered list of motion vector candidates is repeatable on the decoder side only the index of the selected motion vector (MVₛₑₜ) within the ordered list of motion vector candidates may be included in encoded bit-stream rather than a motion vector itself. Over the course of an entire video sequence significantly less information may be needed to encode the index values than actual motion vectors.

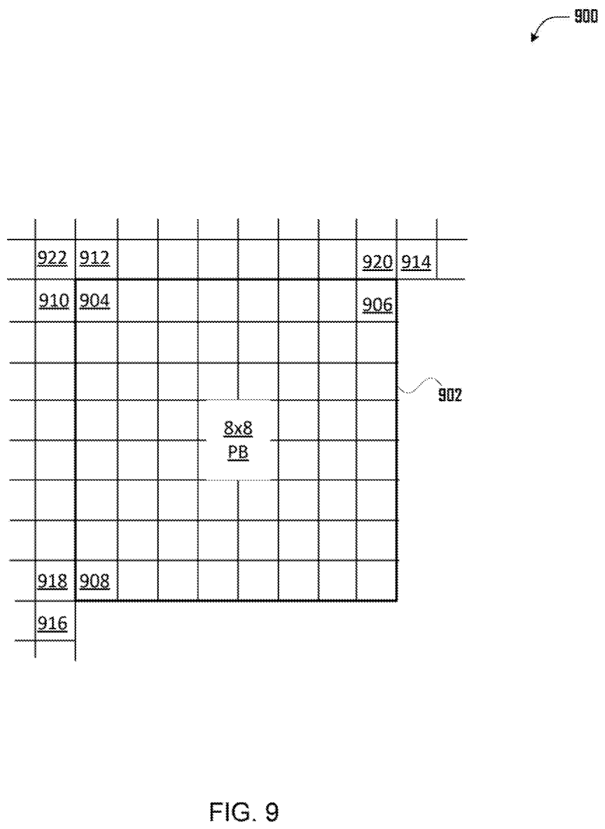

In accordance with an aspect of at least one embodiment, the motion vectors selected to populate the motion vector candidate list are preferably taken from seven reference blocks (RBₐ, RB_{b}, RB_{c}, RB_{d}, RBₑ, RB_{f}, RB_{g}) that have known motion vectors and share a border and/or a vertex with the current prediction block (PB_{cur}). Referring to FIG. 9, which illustrates an 8×8 prediction block 902 having a pixel 904 in the upper left corner, a pixel 906 in the upper right corner, and a pixel 908 in the lower left corner, as the current prediction block (PB_{cur}) by way of example:

(a) the first reference block (RBₐ) may be a prediction block containing a pixel 910 to the left of pixel 904;

(b) the second reference block (RB_{b}) may be a prediction block containing a pixel 912 above pixel 904;

(c) the third reference block (RB_{c}) may be a prediction block containing a pixel 914 above and to the right of pixel 906;

(d) the fourth reference block (RB_{d}) may be a prediction block containing a pixel 916 below and to the left of pixel 908;

(e) the fifth reference block (RBₑ) may be a prediction block containing a pixel 918 to the left pixel 908;

(f) the sixth reference block (RB_{f}) may be a prediction block containing a pixel 920 above pixel 906; and

(g) the seventh reference block (RB_{g}) may be a prediction block containing a pixel 922 above and to the left of pixel 904.

However, the specific locations of the reference blocks relative to the current prediction block may not be important, so long as they are known by a downstream decoder.

In accordance with an aspect of the present embodiment, if all seven reference blocks have known motion vectors, the first motion vector candidate (MVC₁) in the motion vector candidate list for the current prediction block (PB_{cur}) may be the motion vector (MVₐ) (or motion vectors, in a B-type frame) from the first reference block (RBₐ), the second motion vector candidate (MVC₂) may be the motion vector (MV_{b}) (or motion vectors) from the second reference block (RB_{b}), the third motion vector candidate (MVC₃) may be the motion vector (MV_{c}) (or motion vectors) from the third reference block (RB_{c}), the fourth motion vector candidate (MVC₄) in the motion vector candidate list for the current prediction block (PB_{cur}) may be the motion vector (MV_{d}) (or motion vectors, in a B-type frame) from the fourth reference block (RB_{d}).

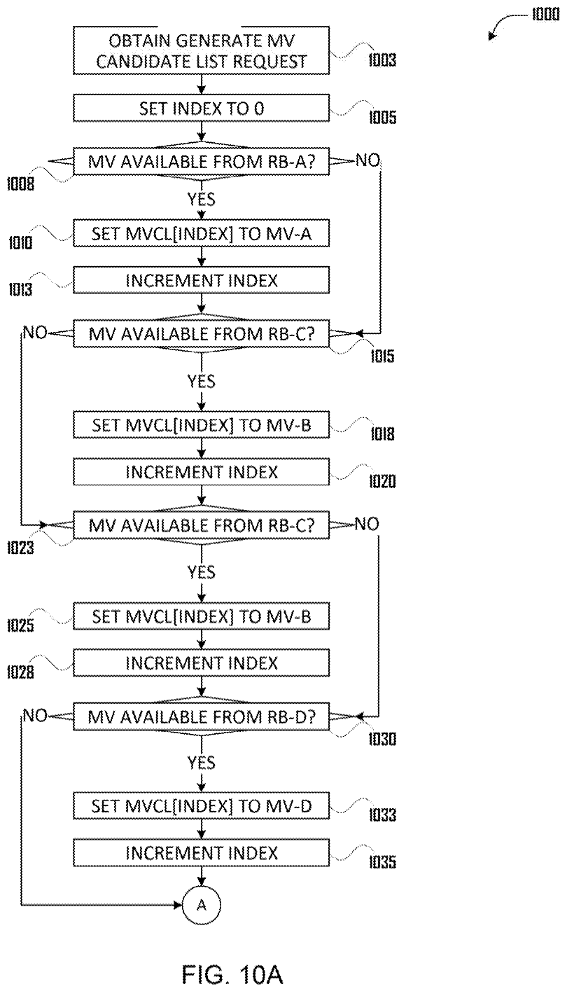

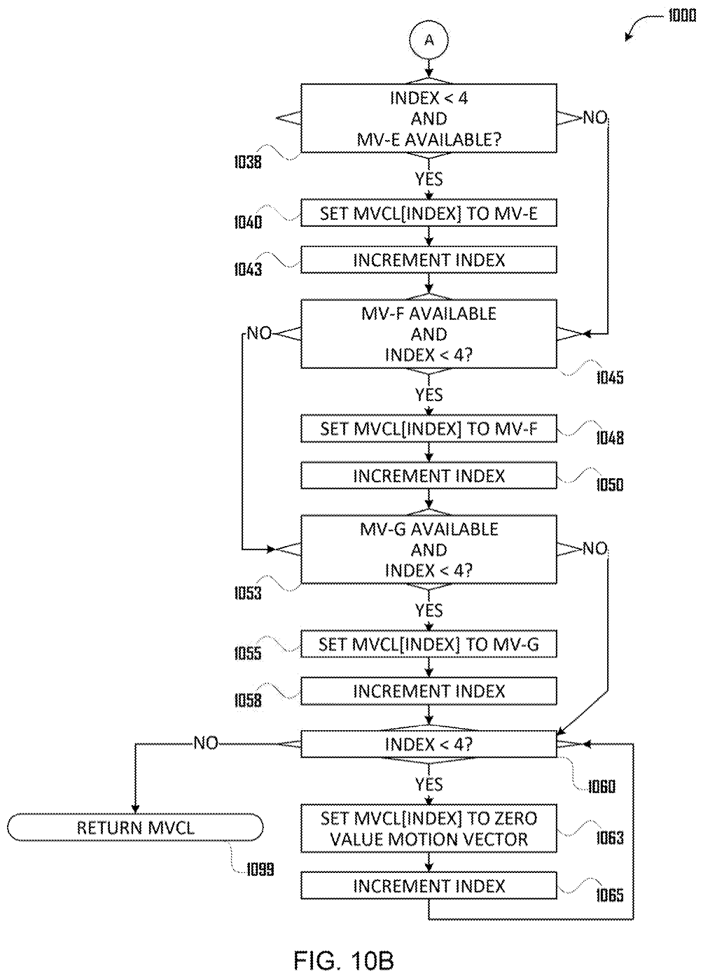

In accordance with the present embodiment, if one or more of the first four reference blocks (RB_{a-d}) are not able to provide motion vector candidates, then the three additional reference blocks (RB_{e-g}) may be considered. However, if one or more of the three additional reference blocks (RB_{e-g}) do not have available motion vectors, e.g., because no prediction information is available for a given reference block or the current prediction block (PB_{cur}) is in the top row, bottom row, leftmost column, or rightmost column of the current frame, that motion vector candidate may be skipped and the next motion vector candidate may take its place, and zero value motion vectors (0,0) may be substituted for the remaining candidate levels. For example, if no motion vector is available for the second, third, and fourth reference blocks RB_{b-d}, the motion vector candidate list may be: (MVa, MVe, (0,0)). An exemplary procedure for populating the motion vector candidate list in accordance with the present embodiment is described below with reference to FIG. 10.

Motion estimator 416 may then evaluate the motion vector candidates and select the best motion vector candidate to be used as the selected motion vector for the current prediction block. Note that as long as a downstream decoder knows how to populate the ordered list of motion vector candidates for a given prediction block, this calculation can be repeated on the decoder side with no knowledge of the contents of the current prediction block. Therefore, only the index of the selected motion vector from the motion vector candidate list needs to be included in encoded bit-stream rather than a motion vector itself, for example by setting a motion-vector-selection flag in the prediction block header of the current prediction block, and thus, over the course of an entire video sequence, significantly less information will be needed to encode the index values than actual motion vectors.

In the direct-coding mode, the motion-vector-selection flag and the residual between the current prediction block and the block of the reference frame indicated by the motion vector are encoded. In the skip-coding mode, the motion-vector-selection flag is encoded but the encoding of the residual signal is skipped. In essence, this tells a downstream decoder to use the block of the reference frame indicated by the motion vector in place of the current prediction block of the current frame.

### Alternative Motion-Vector-Candidate-Generation Sub-Routine 1000

FIGS. 10A and 10B illustrate an exemplary motion-vector-candidate-generation sub-routine 1000 for use in generating an ordered list of motion vector candidates in accordance with at least one embodiment. In the illustrated embodiment, three motion vector candidates are generated. However, those having ordinary skill in the art will recognize that greater or fewer amounts of candidates may be generated using the same technique, and further that alternate and/or equivalent implementations may be substituted for the specific embodiments shown and described without departing from the scope of the present disclosure.

Alternative motion-vector-candidate generation sub-routine 1000 obtains a request to generate a motion-vector-candidate list for the current prediction block at execution block 1003.

Alternative motion-vector-candidate generation sub-routine 1000 sets an index value (i) to zero at execution block 1005.

At decision block 1008, if the first candidate reference block (RBₐ) does not have a motion vector (MVa) available, alternative motion-vector-candidate generation sub-routine 1000 proceeds to decision block 1015; if the first candidate reference block (RBₐ) does have an available motion vector (MVa), then alternative motion-vector-candidate generation sub-routine 1000 proceeds to execution block 1010.

Alternative motion-vector-candidate generation sub-routine 1000 assigns the first candidate reference block's motion vector (MVa) to be the ith motion vector candidate in the motion vector candidate list (MCVL[i]) at execution block 1010.

Alternative motion-vector-candidate generation sub-routine 1000 increments the index value (i) at execution block 1013.

At decision block 1015, if the second candidate reference block (RBb) does not have a motion vector (MVb) available, alternative motion-vector-candidate generation sub-routine 1000 proceeds to decision block 1023; if the second candidate reference block (RBb) does have an available motion vector (MVb), then alternative motion-vector-candidate generation sub-routine 1000 proceeds to execution block 1018.

Alternative motion-vector-candidate generation sub-routine 1000 assigns the second candidate reference block's motion vector (MVb) to be the ith motion vector candidate in the motion vector candidate list (MCVL[i]) at execution block 1018.

Alternative motion-vector-candidate generation sub-routine 1000 increments the index value (i) at execution block 1020.

At decision block 1023, if the third candidate reference block (RBc) does not have a motion vector (MVc) available, alternative motion-vector-candidate generation sub-routine 1000 proceeds to decision block 1030; if the third candidate reference block (RBc) does have an available motion vector (MVc), then alternative motion-vector-candidate generation sub-routine 1000 proceeds to execution block 1025.

Alternative motion-vector-candidate generation sub-routine 1000 assigns the third candidate reference block's motion vector (MVc) to be the ith motion vector candidate in the motion vector candidate list (MCVL[i]) at execution block 1025.

Alternative motion-vector-candidate generation sub-routine 1000 increments the index value (i) at execution block 1028.

At decision block 1030, if the fourth candidate reference block (RBd) does not have a motion vector (MVd) available, alternative motion-vector-candidate generation sub-routine 1000 proceeds to decision block 1038; if the fourth candidate reference block (RBd) does have an available motion vector (MVd), then alternative motion-vector-candidate generation sub-routine 1000 proceeds to execution block 1033.

Alternative motion-vector-candidate generation sub-routine 1000 assigns the fourth candidate reference block's motion vector (MVd) to be the ith motion vector candidate in the motion vector candidate list (MCVL[i]) at execution block 1033.

Alternative motion-vector-candidate generation sub-routine 1000 increments the index value (i) at execution block 1035.

At decision block 1038, if the index value (i) is less than four, indicating less than four motion vector candidates have been identified up to this point in alternative motion-vector-candidate generation sub-routine 1000, and the fifth candidate reference block (RBe) has a motion vector (MVe) available, alternative motion-vector-candidate generation sub-routine 1000 proceeds to execution block 1040; otherwise, alternative motion-vector-candidate generation sub-routine 1000 proceeds to decision block 1045.

Alternative motion-vector-candidate generation sub-routine 1000 assigns the fifth candidate reference block's motion vector (MVe) to be the ith motion vector candidate in the motion vector candidate list (MCVL[i]) at execution block 1040.

Alternative motion-vector-candidate generation sub-routine 1000 increments the index value (i) at execution block 1043.

At decision block 1045, if the index value (i) is less than four and the sixth candidate reference block (RBf) has a motion vector (MVf) available, alternative motion-vector-candidate generation sub-routine 1000 proceeds to execution block 1048; otherwise, alternative motion-vector-candidate generation sub-routine 1000 proceeds to decision block 1053.

Alternative motion-vector-candidate generation sub-routine 1000 assigns the sixth candidate reference block's motion vector (MVf) to be the ith motion vector candidate in the motion vector candidate list (MCVL[i]) at execution block 1048.

Alternative motion-vector-candidate generation sub-routine 1000 increments the index value (i) at execution block 1050.

At decision block 1053, if the index value (i) is less than four and the seventh candidate reference block (RBg) has a motion vector (MVg) available, alternative motion-vector-candidate generation sub-routine 1000 proceeds to execution block 1055; otherwise, alternative motion-vector-candidate generation sub-routine 1000 proceeds to decision block 1060.

Alternative motion-vector-candidate generation sub-routine 1000 assigns the seventh candidate reference block's motion vector (MVg) to be the ith motion vector candidate in the motion vector candidate list (MCVL[i]) at execution block 1055.

Alternative motion-vector-candidate generation sub-routine 1000 increments the index value (i) at execution block 1058.

At decision block 1060, if the index value (i) is less than four, alternative motion-vector-candidate generation sub-routine 1000 proceeds to execution block 1063; otherwise, alternative motion-vector-candidate generation sub-routine 1000 proceeds to return block 1099.

Alternative motion-vector-candidate generation sub-routine 1000 assigns a zero value motion vector to be the ith motion vector candidate in the motion vector candidate list (MCVL[i]) at execution block 1063.

Alternative motion-vector-candidate generation sub-routine 1000 increments the index value (i) at execution block 1065 and then loops back to decision block 1060.

Alternative motion-vector-candidate generation sub-routine 1000 returns the motion vector candidate list (MCVL) at return block 1099.

### Recursive Coding Block Splitting Schema

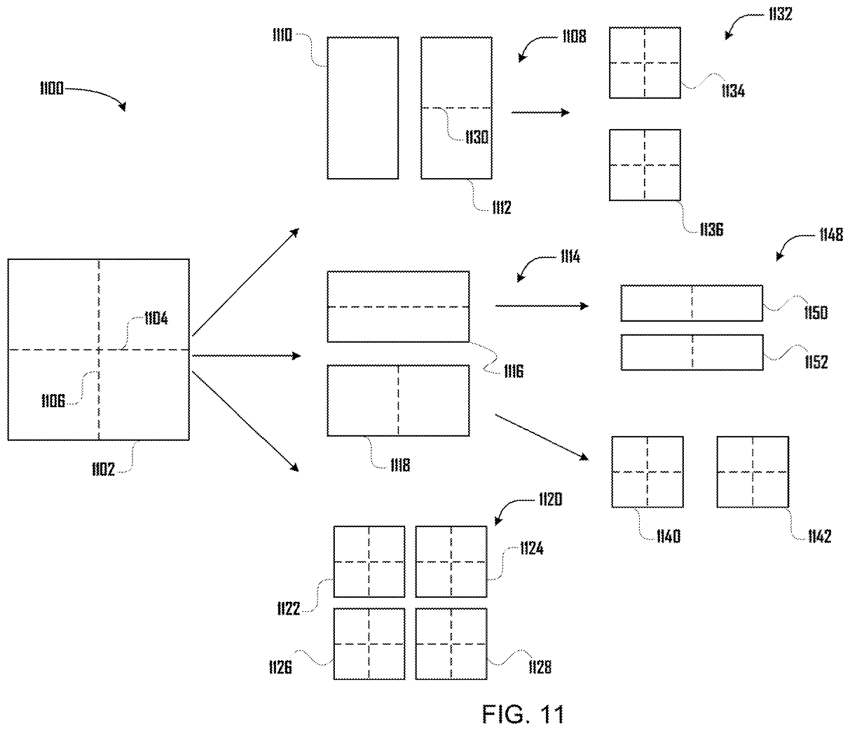

FIG. 11 illustrates an exemplary recursive coding block splitting schema 1100 that may be implemented by encoder 400 in accordance with various embodiments. At block indexer 408, after a frame is divided into LCB-sized regions of pixels, referred to below as coding block candidates (“CBCs”) each LCB-sized coding block candidate (“LCBC”) may be split into smaller CBCs according to recursive coding block splitting schema 1100. This process may continue recursively until block indexer 408 determines (1) the current CBC is appropriate for encoding (e.g., because the current CBC contains only pixels of a single value) or (2) the current CBC is the minimum size for a coding block candidate for a particular implementation, e.g., 2×2, 4×4, etc. (an “MCBC”), whichever occurs first. Block indexer 408 may then index the current CBC as a coding block suitable for encoding.

A square CBC 1102, such as an LCBC, may be split along one or both of vertical and horizontal transverse axes 1104, 1106. A split along vertical transverse axis 1104 vertically splits square CBC 1102 into a first rectangular coding block structure 1108, as is shown by rectangular (1:2) CBCs 1110 and 1112. A split along horizontal transverse axis 1106 horizontally spits square CBC 1102 into a second rectangular coding block structure 1114, as is shown by rectangular (2:1) CBCs 1116 and 1118, taken together.

A rectangular (2:1) CBC of first rectangular coding structure 1114, such as CBC 1116, may be split into a two rectangular coding block structure 1148, as is shown by rectangular CBCs 1150 and 1152, taken together.

A split along both horizontal and vertical transverse axes 1104, 1106 splits square CBC 1102 into a four square coding block structure 1120, as is shown by square CBCs 1122, 1124, 1126, and 1128, taken together.

A rectangular (1:2) CBC of first rectangular coding block structure 1108, such as CBC 1112, may be split along a horizontal transverse axis 1130 into a first two square coding block structure 1132, as is shown by square CBCs 1134 and 1136, taken together.

A rectangular (2:1) CBC of second rectangular coding structure 1114, such as CBC 1118, may be split into a second two square coding block structure 1138, as is shown by square CBCs 1140 and 1142, taken together.

A square CBC of four square coding block structure 1120, the first two square coding block structure 1132, or the second two square coding block structure 1138, may be split along one or both of the coding block's vertical and horizontal transverse axes in the same manner as CBC 1102.

For example, a 64×64 bit LCBC sized coding block may be split into two 32×64 bit coding blocks, two 64×32 bit coding blocks, or four 32×32 bit coding blocks.

In the encoded bitstream, a two bit coding block split flag may be used to indicate whether the current coding block is split any further:

| Coding Block Split | |
|---|---|
| Flag Value | Split Type |
| 00 | The current coding block is not split |
| 01 | The current coding block is horizontally split |
| 10 | The current coding block is vertically split |
| 11 | The current coding block is horizontally and |
| | vertically split |

### Coding Block Indexing Routine

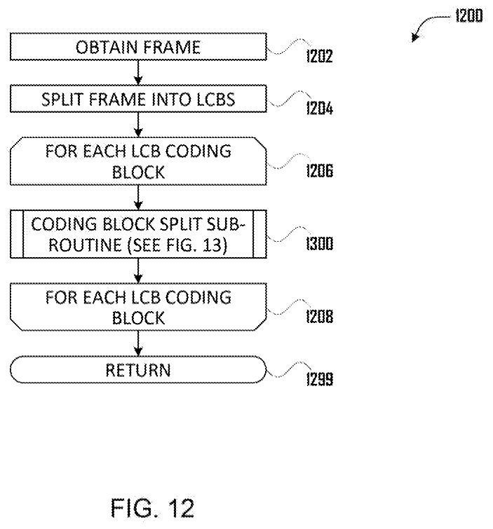

FIG. 12 illustrates an exemplary coding block indexing routine 1200, such as may be performed by blocks indexer 408 in accordance with various embodiments.

Coding block indexing routine 1200 may obtain a frame of a video sequence at execution block 1202.

Coding block indexing routine 1200 may split the frame into LCBCs at execution block 1204.

At starting loop block 1206, coding block indexing routine 1200 may process each LCBC in turn, e.g., starting with the LCBC in the upper left corner of the frame and proceeding left-to-right, top-to-bottom.

At sub-routine block 1300, coding block indexing routine 1200 calls coding block splitting sub-routine 1300, described below in reference to FIG. 13.

At ending loop block 1208, coding block indexing routine 1200 loops back to starting loop block 1206 to process the next LCBC of the frame, if any.

Coding block indexing routine 1200 ends at return block 1299.

### Coding Block Splitting Sub-Routine

FIG. 13 illustrates an exemplary coding block splitting sub-routine 1300, such as may be performed by blocks indexer 408 in accordance with various embodiments.

Sub-routine 1300 obtains a CBC at execution block 1302. The coding block candidate may be provided from routine 1200 or recursively, as is described below.

At decision block 1304, if the obtained CBC is an MCBC, then coding block splitting sub-routine 1300 may proceed to execution block 1306; otherwise coding block splitting sub-routine 1300 may proceed to execution block 1308.

Coding block splitting sub-routine 1300 may index the obtained CBC as a coding block at execution block 1306. Coding block splitting sub-routine 1300 may then terminate at return block 1398.

Coding block splitting sub-routine 1300 may test the encoding suitability of the current CBC at execution block 1308. For example, coding block splitting sub-routine 1300 may analyze the pixel values of the current CBC and determine whether the current CBC only contains pixels of a single value, or whether the current CBC matches a predefined pattern.

At decision block 1310, if the current CBC is suitable for encoding, coding block splitting sub-routine 1300 may proceed to execution block 1306; otherwise coding block splitting sub-routine 1300 may proceed to block 1314.

Coding block splitting sub-routine 1300 may select a coding block splitting structure for the current square CBC at execution block 1314. For example, coding block splitting sub-routine 1300 may select between first rectangular coding block structure 1108, second rectangular coding structure 1114, or four square coding block structure 1120 of recursive coding block splitting schema 1100, described above with reference to FIG. 11.

Coding block splitting sub-routine 1300 may split the current CBC into two or four child CBCs in accordance with recursive coding block splitting schema 1100 at execution block 1316.

At starting loop block 1318, coding block splitting sub-routine 1300 may process each child CBC resulting from the splitting procedure of execution block 1316 in turn.

At sub-routine block 1300, coding block splitting sub-routine 1300 may call itself to process the current child CBC in the manner presently being described.

At ending loop block 1320, coding block splitting sub-routine 1300 loops back to starting loop block 1318 to process the next child CBC of the current CBC, if any.

Coding block splitting sub-routine 1300 may then terminate at return block 1399.

### Coding Block Tree Splitting Procedure

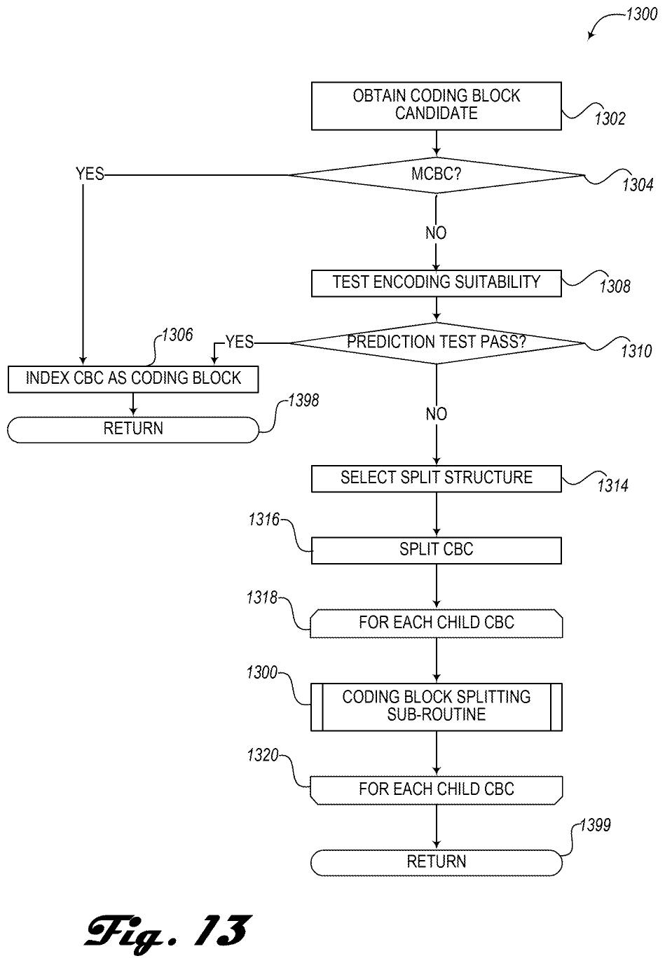

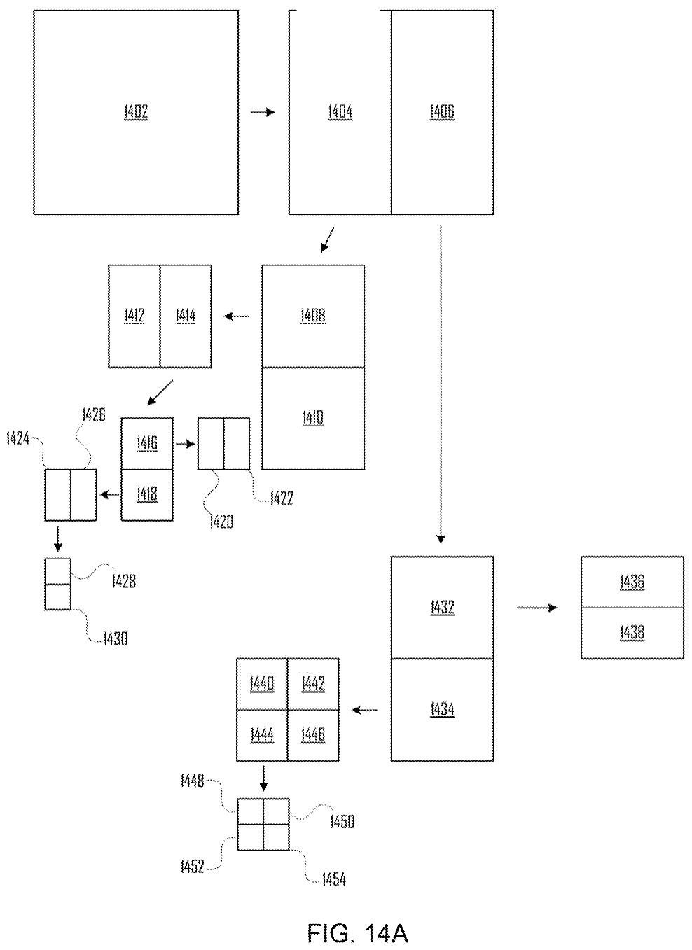

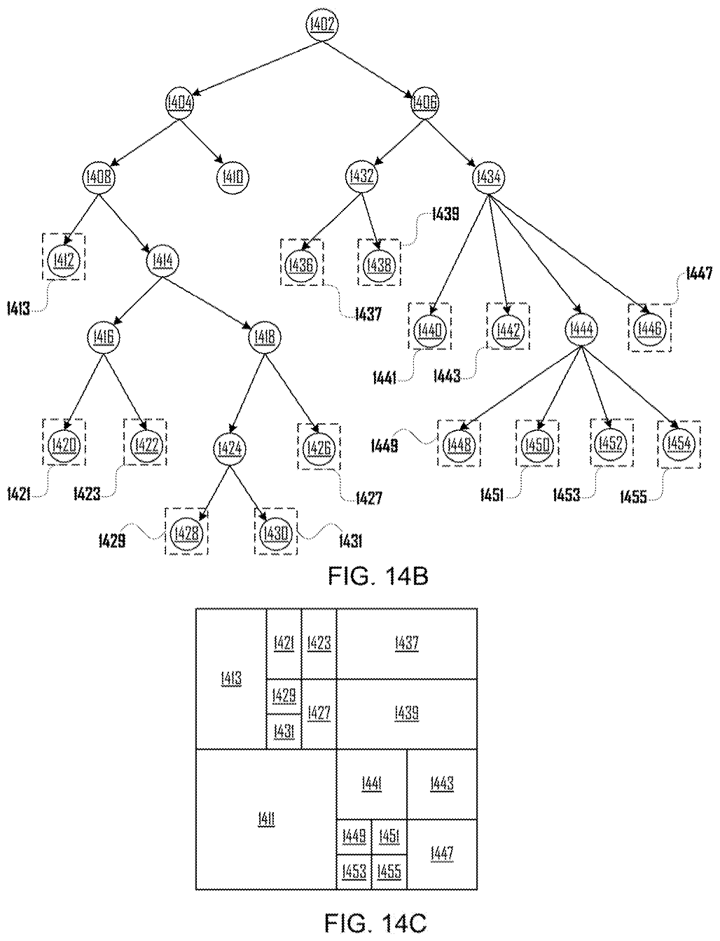

FIGS. 14A-14C illustrate an exemplary coding block tree splitting procedure applying coding block splitting schema 1100 to a “root” LCBC 1402. FIG. 14A illustrates the various child coding blocks 1404-1454 created by coding block tree splitting procedure; FIG. 14B illustrates coding block tree splitting procedure as a tree data structure, showing the parent/child relationships between various coding blocks 1402-1454; FIG. 14C illustrates the various “leaf node” child coding blocks of FIG. 14B, indicated by dotted line, in their respective positions within the configuration of root coding block 1402.

Assuming 64×64 LCBC 1402 is not suitable for encoding, it may be split into ether first rectangular coding block structure 1108, second rectangular coding structure 1114, or four square coding block structure 1120 of recursive coding block splitting schema 1100, described above with reference to FIG. 11. For purposes of this example, it is assumed 64×64 LCBC 1402 is split into two 32×64 child CBCs, 32×64 CBC 1404 and 32×64 CBC 1406. Each of these child CBCs may then be processed in turn.

Assuming the first child of 64×64 LCBC 1402, 32×64 CBC 1404, is not suitable for encoding, it may then be split into two child 32×32 coding block candidates, 32×32 CBC 1408 and 32×32 CBC 1410. Each of these child CBCs may then be processed in turn.

Assuming the first child of 32×64 CBC 1404, 32×32 CBC 1408, is not suitable for encoding, it may then be split into two child 16×32 coding block candidates, 16×32 CBC 1412 and 16×32 CBC 1414. Each of these child CBCs may then be processed in turn.

Encoder 400 may determine that the first child of 32×32 CBC 1408, 16×32 CBC 1412, is suitable for encoding; encoder 400 may therefore index 16×32 CBC 1412 as a coding block 1413 and return to parent 32×32 CBC 1408 to process its next child, if any.

Assuming the second child of 32×32 CBC 1408, 16×32 CBC 1414, is not suitable for encoding, it may be split into two child 16×16 coding block candidates, 16×16 CBC 1416 and 16×16 1418. Each of these child CBCs may then be processed in turn.

Assuming the first child of 16×32 CBC 1414, 16×16 CBC 1416 is not suitable for encoding, it may be split into two child 8×16 coding block candidates, 8×16 CBC 1420 and 8×16 CBC 1422. Each of these child CBCs may then be processed in turn.

Encoder 400 may determine that the first child of 16×16 CBC 1416, 8×16 CBC 1420, is suitable for encoding; encoder 400 may therefore index 8×16 CBC 1420 as a coding block 1421 and return to parent 16×16 CBC 1416, to process its next child, if any.

Encoder 400 may determine that the second child of 16×16 CBC 1416, 8×16 CBC 1422, is suitable for encoding; encoder 400 may therefore index 8×16 CBC 1422 as a coding block 1423 and return to parent 16×16 CBC 1416, to process its next child, if any.

All children of 16×16 CBC 1416 have now been processed, resulting in the indexing of 8×16 coding blocks 1421 and 1423. Encoder 400 may therefore return to parent 16×32 CBC 1414 to process its next child, if any.

Assuming the second child of 16×32 CBC 1414, 16×16 CBC 1418, is not suitable for encoding, it may be split into two 8×16 coding block candidates, 8×16 CBC 1424 and 8×16 CBC 1426. Each of these child CBCs may then be processed in turn.

Assuming the first child of 16×16 CBC 1418, 8×16 CBC 1424, is not suitable for encoding, it may be split into two 8×8 coding block candidates, 8×8 CBC 1428 and 8×8 CBC 1430. Each of these child CBCs may then be processed in turn.

Encoder 400 may determine that the first child of 8×16 CBC 1424, 8×8 CBC 1428, is suitable for encoding; encoder 400 may therefore index 8×8 CBC 1428 as a coding block 1429 and then return to parent 8×16 CBC 1424, to process its next child, if any.

Encoder 400 may determine that the second child of 8×16 CBC 1424, 8×8 CBC 1430, is suitable for encoding; encoder 400 may therefore index 8×8 CBC 1430 as a coding block 1431 and then return to parent 8×16 CBC 1424, to process its next child, if any.

All children of 8×16 CBC 1424 have now been processed, resulting in the indexing of 8×8 coding blocks 1429 and 1431. Encoder 400 may therefore return to parent 16×16 CBC 1418 to process its next child, if any.

Encoder 400 may determine that the second child of 16×16 CBC 1418, 8×16 CBC 1426, is suitable for encoding; encoder 400 may therefore index 8×16 CBC 1426 as a coding block 1427 and then return to parent 16×16 CBC 1418 to process its next child, if any.

All children of 16×16 CBC 1418 have now been processed, resulting in the indexing of 8×8 coding blocks 1429 and 1431 and 8×16 coding block 1427. Encoder 400 may therefore return to parent, 16×32 CBC 1414 to process its next child, if any.

All children of 16×32 CBC 1414 have now been processed, resulting in the indexing of 8×8 coding blocks 1429 and 1431, 8×16 coding blocks 1421, 1423, and 1427. Encoder 400 may therefore return to parent 32×32 CBC 1408 to process its next child, if any.

All children of 32×32 CBC 1408 have now been processed, resulting in the indexing of 8×8 coding blocks 1429 and 1431, 8×16 coding blocks 1421, 1423, and 1427, and 16×32 coding block 1413. Encoder 400 may therefore return to parent 32×64 CBC 1404 to process its next child, if any.

Encoder 400 may determine that the second child 32×64 CBC 1404, 32×32 CBC 1410 is suitable for encoding; encoder 400 may therefore index 32×32 CBC 1410 as a coding block 1411 and then return to parent 32×64 CBC 1404 to process its next child, if any.

All children of 32×64 CBC 1404 have now been processed, resulting in the indexing of 8×8 coding blocks 1429 and 1431; 8×16 coding blocks 1421, 1423, and 1427; 16×32 coding block 1413; and 32×32 coding block 1411. Encoder 400 may therefore return to parent, root 64×64 LCBC 1402 to process its next child, if any.

Assuming the second child of 64×64 LCBC 1402, 32×64 CBC 1406, is not suitable of encoding, it may be split into two 32×32 coding block candidates, 32×32 CBC 1432 and 32×32 CBC 1434. Each of these child CBCs may then be processed in turn.

Assuming the first child of 32×64 CBC 1406, 32×32 CBC 1432, is not suitable for encoding, it may be split into two 32×16 coding block candidates, 32×16 CBC 1436 and 32×16 CBC 1438. Each of these child CBCs may then be processed in turn.

Encoder 400 may determine that the first child of 32×32 CBC 1432, 32×16 CBC 1436, is suitable for encoding; encoder 400 may therefore index 32×16 CBC 1436 as a coding block 1437 and then return to parent 32×32 CBC 1432 to process its next child, if any.

Encoder 400 may determine that the second child of 32×32 CBC 1432, 32×16 CBC 1438, is suitable for encoding; encoder 400 may therefore index 32×16 CBC 1438 as a coding block 1439 and then return to parent, 32×32 CBC 1432 to process its next child, if any.

All children of 32×32 CBC 1432 have now been processed, resulting in the indexing of 32×16 coding blocks 1437 and 1439. Encoder 400 may therefore return to parent 32×64 CBC 1406 to process its next child, if any.

Assuming the second child of 32×64 CBC 1406, 32×32 CBC 1434, is not suitable for encoding, it may be split into four 16×16 coding block candidates, 16×16 CBC 1440, 16×16 CBC 1442, 16×16 CBC 1444, and 16×16 CBC 1446. Each of these child CBCs may then be processed in turn.

Encoder 400 may determine that the first child of 32×32 CBC 1434, 16×16 CBC 1440, is suitable for encoding; encoder 400 may therefore index 16×16 CBC 1440 as a coding block 1441 and then return to parent 32×32 CBC 1434 to process its next child, if any.

Encoder 400 may determine that the second child of 32×32 CBC 1434, 16×16 CBC 1442, is suitable for encoding; encoder 400 may therefore index 16×16 CBC 1442 as a coding block 1443 and then return to parent 32×32 CBC 1434 to process its next child, if any.

Assuming the third child of 32×32 CB, 16×16 CBC 1444, is not suitable for encoding, it may be split into four 8×8 coding block candidates, 8×8 CBC 1448, 8×8 CBC 1450, 8×8 CBC 1452, and 8×8 CBC 1454. Each of these child CBCs may then be processed in turn.

Encoder 400 may determine that the first child of 16×16 CBC 1444, 8×8 CBC 1448, is suitable for encoding; encoder 400 may therefore index 8×8 CBC 1448 as a coding block 1449 and then return to parent 16×16 CBC 1444 to process its next child, if any.

Encoder 400 may determine that the second child of 16×16 CBC 1444, 8×8 CBC 1450, is suitable for encoding; encoder 400 may therefore index 8×8 CBC 1450 as a coding block 1451 and then return to parent 16×16 CBC 1444 to process its next child, if any.

Encoder 400 may determine that the third child of 16×16 CBC 1444, 8×8 CBC 1452, is suitable for encoding; encoder 400 may therefore index 8×8 CBC 1452 as a coding block 1453 and then return to parent 16×16 CBC 1444, to process its next child, if any.

Encoder 400 may determine that the fourth child of 16×16 CBC 1444, 8×8 CBC 1454, is suitable for encoding; encoder 400 may therefore index 8×8 CBC 1454 as a coding block 1455 and then return to parent 16×16 CBC 1444 to process its next child, if any.

All children of 16×16 CBC 1444 have now been processed, resulting in 8×8 coding blocks 1449, 1451, 1453, and 1455. Encoder 400 may therefore return to parent 32×32 CBC 1434 to process its next child, if any.

Encoder 400 may determine that the fourth child of 32×32 CBC 1434, 16×16 CBC 1446, is suitable for encoding; encoder 400 may therefore index 16×16 CBC 1446 as a coding block 1447 and then return to parent 32×32 CBC 1434 to process its next child, if any.

All children of 32×32 CBC 1434 have now been processed, resulting in the indexing of 16×16 coding blocks 1441, 1443, and 1447 and 8×8 coding blocks 1449, 1451, 1453, and 1455. Encoder 400 may therefore return to parent 32×64 CBC 1406 to process its next child, if any.

All children of 32×64 CBC 1406 have now been processed, resulting in the indexing of 32×16 coding blocks 1437 and 1439; 16×16 coding blocks 1441, 1443, and 1447; and 8×8 coding blocks 1449, 1451, 1453, and 1455. Encoder 400 may therefore return to parent, root 64×64 LCBC 1402, to process its next child, if any.

All children of root 64×64 LCBC 1402 have now been processed, resulting in the indexing of 8×8 coding blocks 1429, 1431, 1449, 1451, 1453, and 1455; 8×16 coding blocks 1421, 1423, and 1427; 16×32 coding block 1413, 32×32 coding block 1411; 32×16 coding blocks 1437 and 1439; and 16×16 coding blocks 1441, 1443, and 1447. Encoder 400 may therefore proceed to the next LCBC of the frame, if any.

### Template Matching Prediction Selection Technique

In accordance with aspects of various embodiments of the present methods and systems, to select an intra-predictor for a rectangular coding block, encoder 400 may attempt to match a prediction boundary template for the rectangular coding block to already encoded portions of the current video frame. A prediction boundary template is an L-shaped region of pixels above and to the left of the current coding block.

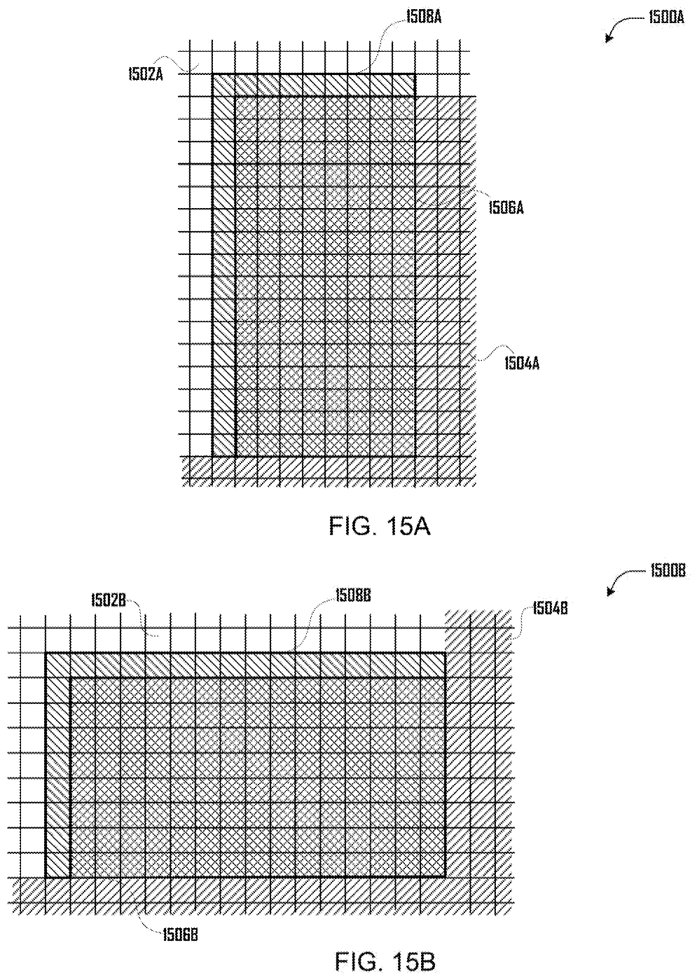

FIGS. 15A and 15B illustrates two regions of pixels 1500A, 1500B corresponding to a portion of a video frame. The regions of pixels 1500A and 1500B are shown as being partially encoded, with each having a processed region 1502A and 1502B, an unprocessed region 1504A and 1504B (indicated by single cross-hatching), and a current coding block 1506A and 1506B (indicated by double cross-hatching). Processed regions 1502A and 1502B represent pixels that have already been indexed into coding blocks by blocks indexer 408 and processed by intra predictor 444 or motion compensated predictor 442. Unprocessed regions 1504A and 1504B represent pixels that have not been processed by intra predictor 444. Current coding blocks 1506A and 1506B are rectangular coding blocks currently being processed by intra predictor 444. (The size of coding blocks 1506A and 1506B are selected arbitrarily for illustrative purposes—the current technique may be applied to any rectangular coding block in accordance with the present methods and systems.) The pixels directly above and to the left of coding blocks 1506A and 1506B form exemplary prediction templates 1508A and 1508B. A prediction template is an arrangement of pixels in the vicinity of the current coding block that have already been processed by intra predictor 444 or motion compensated predictor 442 and therefore already have prediction values associated therewith. In accordance with some embodiments, a prediction template may include pixels that border pixels of the current coding block. The spatial configuration of prediction templates 1508A and 1508B form “L” shaped arrangements that border pixels of coding blocks 1506A and 1506B along the coding blocks' upper and left sides (i.e., the two sides of coding blocks 1506A and 1506B that border processed regions 1502A and 1502B).

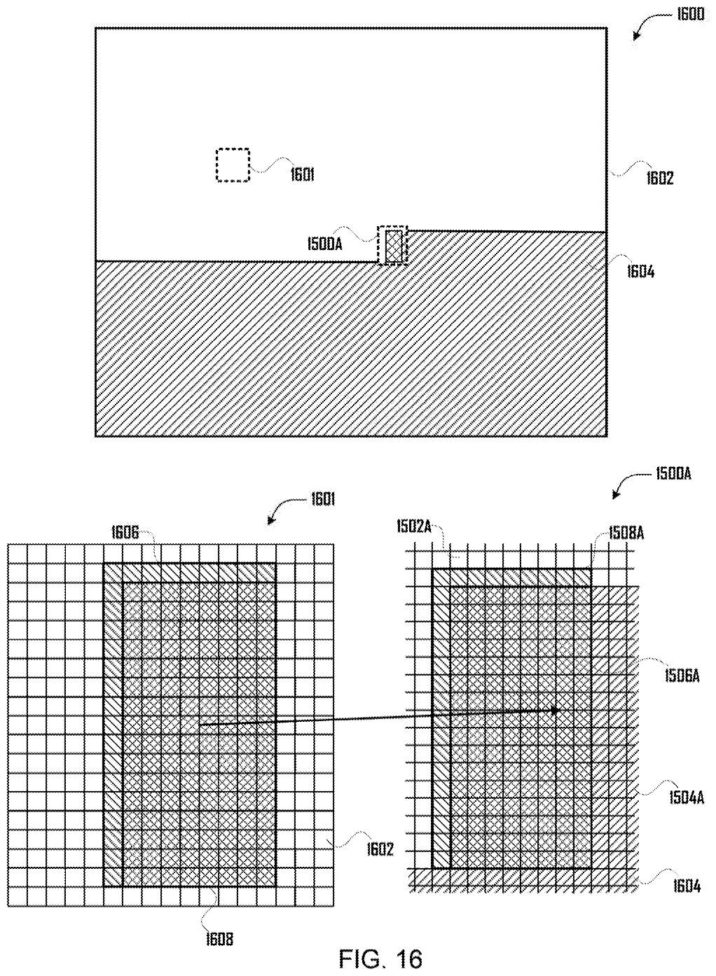

FIG. 16 illustrates how a prediction template may be used in accordance with the present methods and systems to select intra prediction values for the pixels of a rectangular coding block in an exemplary video frame 1600, which includes region of pixels 1500A and therefore current coding block 1506A. Note the size of coding block 1506A with respect to video frame 1600 is exaggerated for illustrative purposes. Region of pixels 1500A is shown both within the context of video frame 1600 and as an enlarged cut out in the lower, right hand portion of FIG. 16. A second region of pixels, region of pixels 1601, is shown both within video frame 1600 and as an enlarged cut out in the lower left hand portion of FIG. 16. Video frame 1600 also includes a processed region 1602, including processed region 1502A and region of pixels 1601, and an unprocessed region 1604, including unprocessed region 1504A.

In accordance with the present methods and systems, to select prediction values for the pixels of coding block 1506A (or any rectangular coding block) encoder 400 may:

(1) identify a prediction template in processed region 1602, such as exemplary prediction template 1508A;

(2) search processed region 1602 for an arrangement of pixels that matches, in terms of both relative spatial configuration and prediction values, prediction template 1508A (for purposes of the present example, arbitrarily selected arrangement of pixels 1606 within region of pixels 1601 is assumed to match prediction template 1508A);

(3) identify a region of pixels 1608 having a corresponding relative spatial relationship to the matching arrangement as the current coding block has to the prediction template; and

(4) map the respective prediction values for each pixel of region of pixels 1608 to the corresponding pixel of the current coding block.

In various embodiments, encoder 400 may apply various tolerances to the matching algorithm when determining if there is a match between a prediction template, such as prediction templates 1508A and 1508B, and a potential matching arrangement of pixels, e.g., arrangement of pixels 1606, such as detecting a match: (a) only if the prediction values of the prediction template and the potential matching arrangement of pixels match exactly; (b) only if all prediction values match +/−2%; (c) only if all except one prediction values match exactly and the remaining prediction value matches +/−5%; (d) only if all prediction values except one match exactly and the remaining prediction value matches +/−5% or all prediction values match +/−2% (i.e., a combination of (b) or (c)); (d) a prediction cost of the prediction template and the potential matching arrangement of pixels is less than a pre-defined threshold value (the prediction cost may, e.g., be sum of absolute difference (SAD), sum of squared error (SSE) or derived from rate-distortion functions); and/or the like.

In various embodiments, the matching algorithm may: (a) stop processing potential matching arrangements of pixels after a tolerable matching arrangement of pixels is found and map the prediction values of the corresponding region of pixels to the pixels to the current coding block; (b) process all possible matching arrangements of pixels, then select the best available matching arrangement of pixels and map the prediction values of the corresponding region of pixels to the pixels of the current coding block; (c) begin processing all possible matching arrangements of pixels, stop if a perfect match is found and map the prediction values of the corresponding region of pixels to the pixels to the current coding block, and otherwise continue to process all possible matching arrangement of pixels, select the best available non-perfect match, and map the prediction values of the corresponding region of pixels to the pixels to the current coding block; and/or the like.

### Rectangular Coding Block Prediction Value Selection Routine

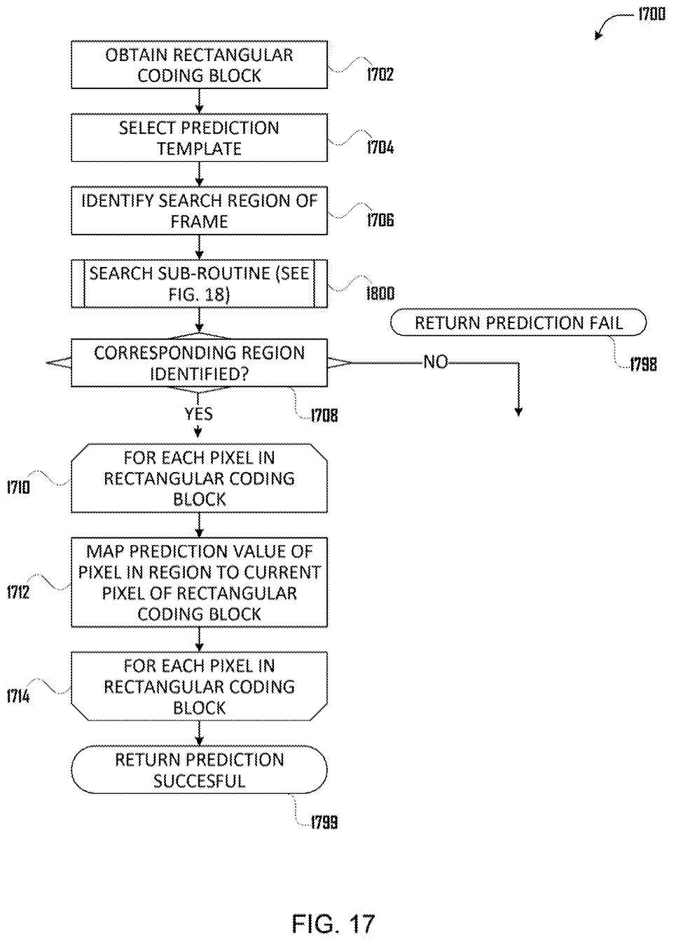

FIG. 17 illustrates an exemplary rectangular coding block prediction value selection routine 1700 which may be implemented by intra predictor 444 in accordance with various embodiments.

Rectangular coding block prediction value selection routine 1700 may obtain a rectangular coding block at execution block 1702. For example, rectangular coding block prediction value selection routine 1700 may obtain a pixel location within a frame, a coding block width dimension, and a coding block height dimension. The pixel location may correspond to the pixel in the upper right hand corner of the current coding block, the coding block width dimension may correspond to a number of pixel columns, and the coding block height dimension may correspond to a number of pixel rows.

Rectangular coding block prediction value selection routine 1700 may select a prediction template for the rectangular coding block at execution block 1704. For example, rectangular coding block prediction value selection routine 1700 may select a prediction template including pixels that border the pixels along the upper and left sides the current coding block, as described above with respect to FIG. 15.

Rectangular coding block prediction value selection routine 1700 may identify a search region in the current frame at execution block 1706. For example, the search region may include all pixels of the current frame that have prediction values already assigned.

At sub-routine block 1800, rectangular coding block prediction value selection routine 1700 calls processed-region search sub-routine 1800, described below with respect to FIG. 18. Sub-routine block 1800 may return either a region of pixels or a prediction failure error.

At decision block 1708, if sub-routine block 1800 returns a prediction fail error, rectangular coding block prediction value selection routine 1700 may terminate unsuccessfully at return block 1798; otherwise rectangular coding block prediction value selection routine 1700 may proceed to starting loop block 1710.

At starting loop block 1710, rectangular coding block prediction value selection routine 1700 may process in turn each pixel of the rectangular coding block in turn. For example, rectangular coding block prediction value selection routine 1700 may process the pixels of the rectangular coding block from left-to-right and from top-to-bottom.

Rectangular coding block prediction value selection routine 1700 may map a prediction value of a pixel of the region of pixels obtained from processed-region search sub-routine 1800 to the current pixel of the rectangular coding block at execution block 1712. For example, the prediction value for the pixel in the upper left corner of the region of pixels may be mapped to the pixel in the upper left corner of the current coding block, etc.

At ending loop block 1714, rectangular coding block prediction value selection routine 1700 may loop back to starting loop block 1710 to process the next pixel of the rectangular coding block, if any.

Rectangular coding block prediction value selection routine 1700 may terminate successfully at return block 1799.

### Processed-Region Search Sub-Routine

FIG. 18 illustrates an exemplary processed-region search sub-routine 1800 which may be implemented by intra predictor 444 in accordance with various embodiments.

Processed-region search sub-routine 1800 may obtain a prediction template and a search region at execution block 1802.

Processed-region search sub-routine 1800 may select an anchor pixel for the prediction template at execution block 1804. For example, if the prediction template is an L shaped arrangement of pixels along the top and left borders of the coding block, the anchor pixel may be the pixel at the intersection of the “L,” one pixel row above and one pixel column to the left of the pixel in the top left corner of the coding block.

At starting loop block 1806, processed-region search sub-routine 1800 may process each pixel of the search region in turn.

Processed-region search sub-routine 1800 may generate a test template having the same arrangement as the prediction template but using the current search region pixel as the test template's anchor pixel at execution block 1808.

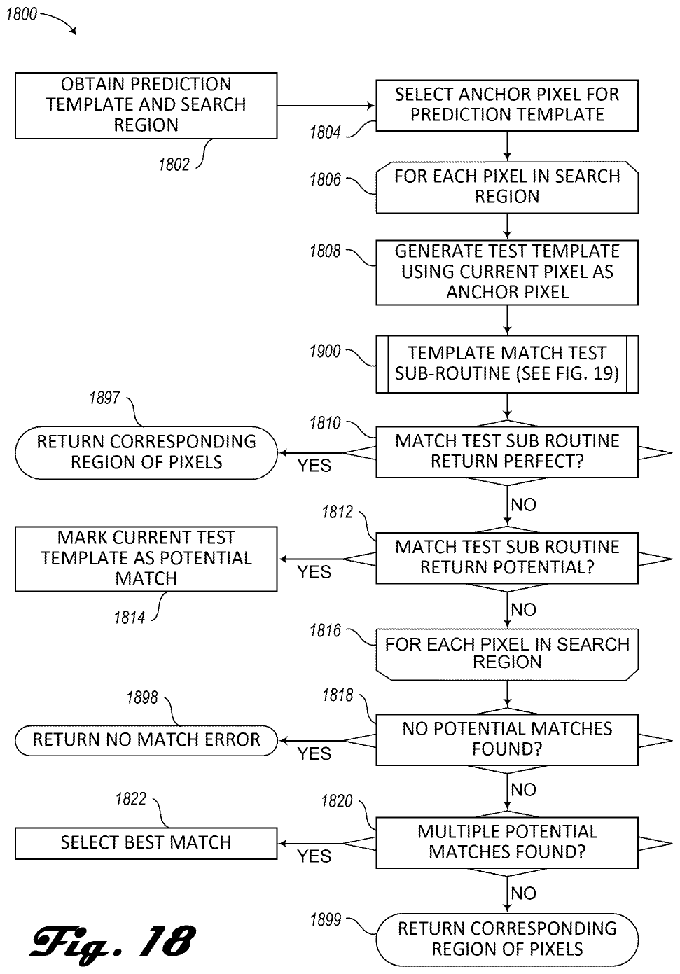

At sub-routine block 1900, processed-region search sub-routine 1800 may call template match test sub-routine 1900, described below with reference to FIG. 19. Template match test sub-routine 1900 may return either a perfect match result, a potential match result, or a no match result.

At decision block 1810, if template match test sub-routine 1900 returns a perfect match result, processed-region search sub-routine 1800 may proceed to return block 1897 and return the region of pixels having the same relative spatial relationship to the current test template as the current coding block has to the prediction template; otherwise processed-region search sub-routine 1800 may proceed to decision block 1812.

At decision block 1812, if template match test sub-routine 1900 returns a potential match result, processed-region search sub-routine 1800 may proceed to execution block 1814; otherwise processed-region search sub-routine 1800 may proceed to ending loop block 1816.

Processed-region search sub-routine 1800 may mark the test template associated with the current search region pixel as corresponding to a potential match at execution block 1814.

At ending loop block 1816, processed-region search sub-routine 1800 may loop back to starting loop block 1806 to process the next pixel of the search region, if any.

At decision block 1818, if no test templates were marked as potential matches; processed-region search sub-routine 1800 may proceed to terminate by returning a no match error at return block 1898; otherwise processed-region search sub-routine 1800 may proceed to decision block 1820.

At decision block 1820, if multiple test templates were found to be potential matches at execution block 1814, then processed-region search sub-routine 1800 may proceed to execution block 1822; otherwise, i.e., only one test template was marked as a potential match, processed-region search sub-routine 1800 may proceed to return block 1899.

Processed-region search sub-routine 1800 may select the best matching test template of the identified potential matching test templates and discard the remaining identified potential matching test templates, leaving only one identified test template.

Processed-region search sub-routine 1800 may terminate at return block 1899 by returning the region of pixels having the same relative spatial relationship to the test template as the current coding block has to the prediction template.

### Template Match Test Sub-Routine

FIG. 19 illustrates an exemplary template match test sub-routine 1900 which may be implemented by intra predictor 444 in accordance with various embodiments.

Template match test sub-routine 1900 may obtain a test template and a prediction template at execution block 1902.

Template match test sub-routine 1900 may set a match variable to true at execution block 1904.

At starting loop 1906, template match test sub-routine 1900 may process each pixel of the test template in turn.

At decision block 1908, if the prediction value of the current test template pixel matches the prediction value of the corresponding prediction template pixel, the template match test sub-routine 1900 may proceed to ending loop block 1912; otherwise template match test sub-routine 1900 may proceed to execution block 1910.

Template match test sub-routine 1900 may set the match variable to false at execution block 1910.

At ending loop block 1912, template match test sub-routine 1900 may loop back to starting loop block 1906 to process the next pixel of the test template, if any.

At decision block 1914, if the value of the match variable is true, then template match test sub-routine 1900 may return a perfect match result at return block 1997; otherwise template match test sub-routine 1900 may proceed to execution block 1916.

Template match test sub-routine 1900 may set the value of the match variable to true at execution block 1916.

At starting loop 1918, template match test sub-routine 1900 may process each pixel of the test template in turn.

At decision block 1920, if the prediction value of the current test template pixel is within a predefined tolerance level of the prediction value of the corresponding prediction template pixel, the template match test sub-routine 1900 may proceed to ending loop block 1924; otherwise template match test sub-routine 1900 may proceed to execution block 1922.

Template match test sub-routine 1900 may set the match variable to false at execution block 1922.

At ending loop block 1924, template match test sub-routine 1900 may loop back to starting loop block 1906 to process the next pixel of the test template, if any.

At decision block 1926, if the value of the match variable is true, then template match test sub-routine 1900 may terminate by returning a potential match result at return block 1998; otherwise template match test sub-routine 1900 may terminate by returning a no match result at return block 1999.

### Directional Prediction Technique

In accordance with aspects of various embodiments of the present methods and systems, to select an intra-predictor for a coding block, encoder 400 may attempt to map already selected prediction values from pixels in the vicinity of the coding block to the pixels of the coding block.

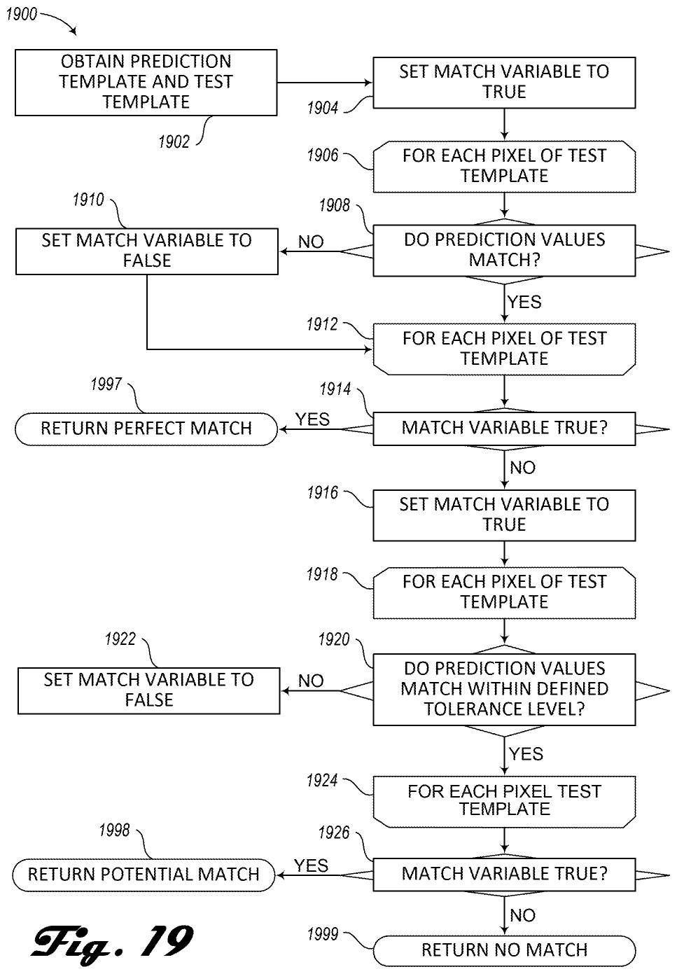

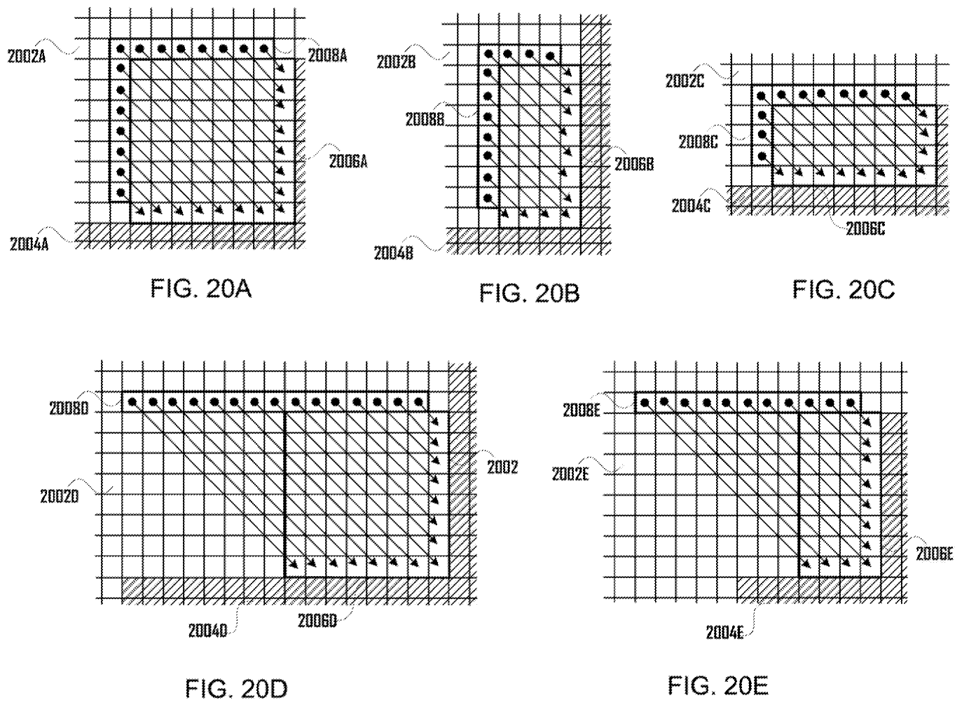

FIGS. 20A-20E illustrate five regions of pixels 2000A-2000E, each corresponding to a portion of a video frame (not shown). Regions of pixels 2000A-2000E are shown as being partially encoded, with each having a processed region 2002A-2002E, an unprocessed region 2004A-2004E (indicated by single cross-hatching), and a current coding block 2006A-2006E. Processed regions 2002A-2002E represent pixels that have already been indexed into coding blocks by blocks indexer 408 and processed by intra predictor 444. Unprocessed regions 2004A-2004E represent pixels that have not been processed by intra predictor 444. Current coding blocks 2006A-2006E are rectangular coding blocks currently being processed by intra predictor 444. (The size of coding blocks 2006A-2006E are selected arbitrarily for illustrative purposes—the current technique may be applied to any coding block in accordance with the present methods and systems.)

In FIGS. 20A-20C, the pixels from the row directly above and the column directly to the left of coding blocks 2006A-2006C form exemplary prediction regions 2008A-2008C. A prediction region is an arrangement of pixels in the vicinity of the current coding block that have already been processed by intra predictor 444 and therefore already have prediction values associated therewith. The relative spatial configuration of the pixels of prediction regions 2008A-2008C form “L” shaped prediction regions that border pixels of coding blocks 2006A-2006C along the coding blocks' upper and left sides (i.e., the two sides of coding blocks 2006A-2006C that border processed regions 2002A-2002C).

In FIGS. 20D and 20E, pixels from the row directly above coding blocks 2006A-2006C form exemplary prediction regions 2008D and 2008E. The relative spatial configuration of the pixels of prediction regions 2008D and 2008E form “bar” shaped prediction regions that border pixels of coding blocks 2006A-2006C along the coding blocks' upper side and extending to the left.

According to various aspects of the present methods and systems, prediction values for the pixels within prediction regions 2008A-2008E may be mapped to diagonally consecutive pixels of the coding blocks 2006A-2006E, e.g., along diagonal vectors having a slope of −1.

According to other aspects of the present methods and systems, the prediction values of pixels in an L-shape prediction region, as shown in FIGS. 20A-20C, may be combined with the prediction values of pixels in a bar shaped prediction region for a single coding block. For example, a prediction value PV may be generated according to Equation 1:

PV=a*P_{L}+(1−α)P_{B}

where P_{L} is a pixel in the L-shape prediction region, P_{B} is a pixel in the bar shaped prediction region and a is a coefficient to control the prediction efficiency.

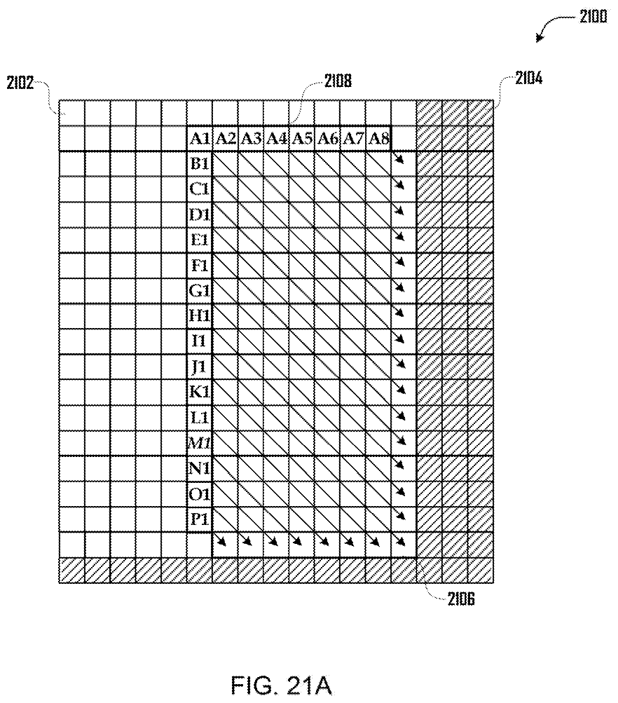

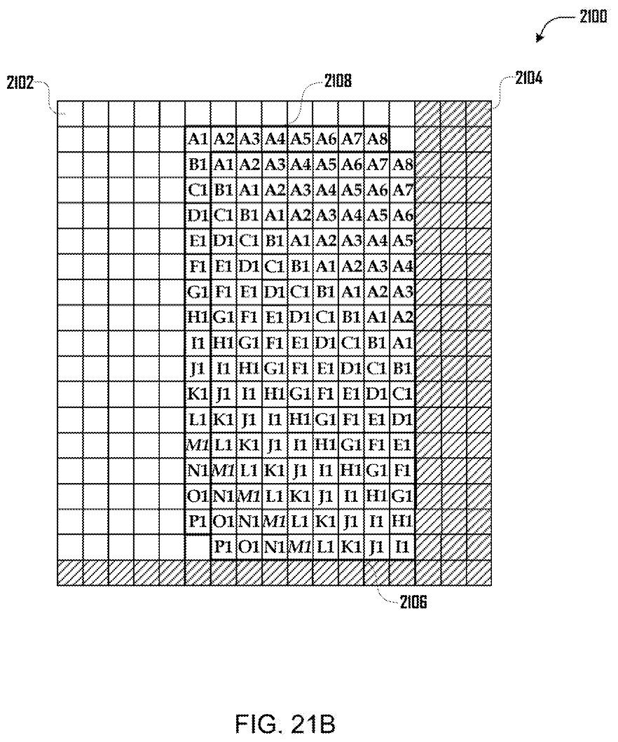

FIGS. 21A and 21B illustrate a region of pixels 2100 corresponding to a portion of a video frame (not shown). Region of pixels 2100 is shown as being partially encoded, having a processed region 2102, an unprocessed region 2104 (indicated by single cross-hatching), and a current coding block 2106. Processed region 2102 represents pixels that have already been indexed into coding blocks by blocks indexer 408 and processed by intra predictor 444. Unprocessed region 2104 represents pixels that have not been processed by intra predictor 444. Current coding block 2106 is an 8×16 rectangular coding blocks currently being processed by intra predictor 444 according to the directional prediction technique described above with respect to FIG. 20.

Prediction region 2108 includes pixels from the row directly above and the column directly to the left of coding block 2106. In FIG. 21A, the prediction value of each pixel of prediction region 2108 is indicated by an alphanumeric indicator corresponding to the pixel's relative row (indicated by letter) and column (indicated by number) within the prediction region. Diagonal vectors extend from each pixel of prediction region 2108 into one or more pixels of coding block 2106, corresponding to the mapping of the prediction values of the prediction region to the pixels of the coding block. In FIG. 21B, the mapped prediction value of each pixel of coding block 2106 is indicated by an alphanumeric indicator corresponding to the source of the pixel's prediction value.

### Directional Prediction Value Selection Routine

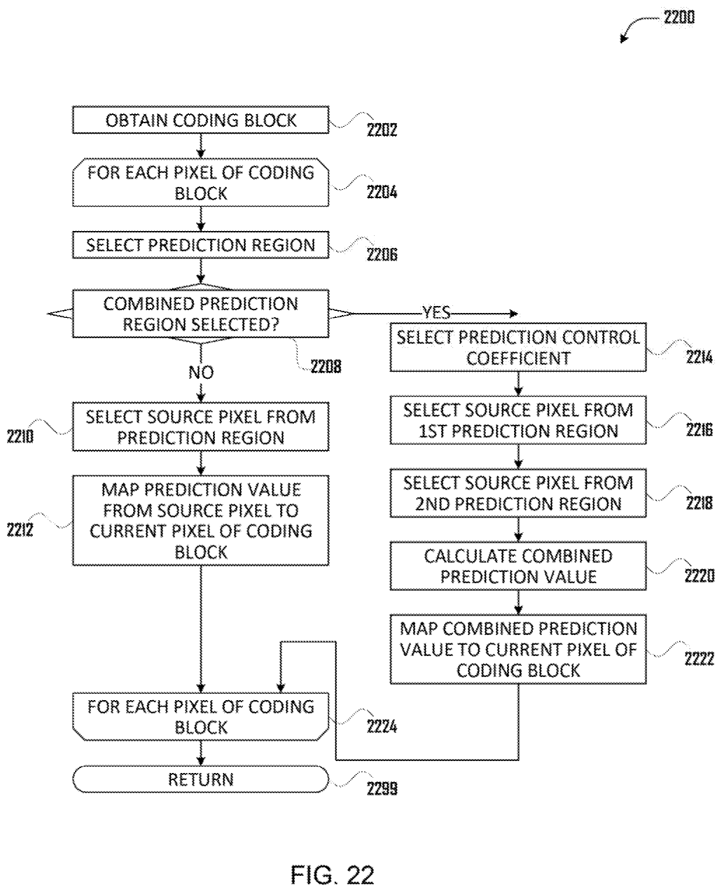

FIG. 22 illustrates an exemplary directional prediction value selection routine 2200 which may be implemented by intra predictor 444 in accordance with various embodiments. For example, if rectangular coding block prediction value selection routine 1700, described above, fails to find suitable prediction values for a coding block, intra predictor 444 may use directional prediction value selection routine 2200 as an alternative.

Directional prediction value selection routine 2200 obtains a coding block at execution block 2202.

At starting loop block 2204, directional prediction value selection routine 2200 processes each pixel of the obtained coding block in turn. For example, directional prediction value selection routine 2200 may process the pixels of the coding block from left-to-right and from top-to-bottom.

Directional prediction value selection routine 2200 may select a prediction region to use to select the prediction value for the current pixel at execution block 2206. For example, directional prediction value selection routine 2200 may select an L shaped prediction region, a bar shaped prediction region, or the like. Directional prediction value selection routine 2200 may also choose to combine multiple prediction regions (for purposes of this example, it is assumed there are only two possible prediction regions for each coding block—the L shaped region and the bar shaped region, described above). Directional prediction value selection routine 2200 may select the same prediction region for each pixel of the current coding block, or may alternate between prediction regions.

At decision block 2208, if directional prediction value selection routine 2200 chose to combine prediction regions, then directional prediction value selection routine 2200 may proceed to execution block 2214, described below; otherwise directional prediction value selection routine 2200 may proceed to execution block 2210.

Directional prediction value selection routine 2200 may select a source pixel from the selected prediction region for the current pixel of the coding block at execution block 2210. For example, directional prediction value selection routine 2200 may select a source pixel based on the diagonal vectors described above with respect to FIGS. 20A-20E.

Directional prediction value selection routine 2200 may map a prediction value from the source pixel to the current pixel of the coding block at execution block 2212. Directional prediction value selection routine 2200 may then proceed to ending loop block 2224.

Returning to decision block 2208, described above, if directional prediction value selection routine 2200 chose to combine prediction regions, then at execution block 2214, directional prediction value selection routine 2200 may select a prediction control coefficient.

Directional prediction value selection routine 2200 may select a source pixel from a first prediction region, e.g., the L shaped prediction region, for the current pixel of the coding block at execution block 2216.

Directional prediction value selection routine 2200 may select a source pixel from a second prediction region, e.g., the bar shaped prediction region, for the current pixel of the coding block at execution block 2218.

Directional prediction value selection routine 2200 may calculate a combined prediction value using the prediction values of the selected source pixels and the selected prediction control coefficient at execution block 2220. For example, directional prediction value selection routine 2200 may calculate the combined prediction value according to Equation 1, above.

Directional prediction value selection routine 2200 may map the combined prediction value to the current pixel of the coding block at execution block 2222.

At ending loop block 2224, directional prediction value selection routine 2200 may loop back to starting loop block 2204 to process the next pixel of the coding block, if any.

Directional prediction value selection routine 2200 may terminate at return block 2299.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1-20. (canceled)

21. A method of encoding an unencoded video frame of a sequence of video frames to generate an encoded bit-stream representative of the unencoded video frame, the unencoded video frame including an array of pixels, the array of pixels including a processed region of pixels and an unprocessed region of pixels, the processed region of pixels having prediction values associated therewith and the unprocessed region not having prediction values associated therewith, and the encoded bit-stream representative of the unencoded video frame including at least a header and a video data payload, the method comprising:
obtaining a first block of pixels of the unprocessed region of pixels, the first block of pixels having a first width and a first height;
selecting a prediction template from the processed region of pixels, the prediction template includes a first plurality of pixels in a first spatial configuration and being in a first position relative to the first block of pixels;
identifying a matching arrangement of pixels within the processed region of pixels that matches the prediction template, wherein the matching arrangement of pixels includes a second plurality of pixels in the first spatial configuration and being in the first position relative to a second block of pixels, the second block of pixels having the first width and the first height; and
associating prediction values with the first block of pixels by, for each respective pixel of the first block of pixels:
identifying a pixel of the second block of pixels that corresponds to the respective pixel of the first block of pixels; and
mapping a prediction value associated with the corresponding pixel in the second block of pixels to the respective pixel of the first block of pixels.

22. The method of claim 21, wherein the first block of pixels has a top side and a left side, and wherein the prediction template has a bottom side and a right side with the bottom side of the prediction template abutting the top side of the first block of pixels and the right side of the prediction template abutting the left side of the first block of pixels.

23. The method of claim 21, wherein the second block of pixels has a top side and a left side, and wherein the matching arrangement of pixels has a bottom side and a right side with the bottom side of the matching arrangement of pixels abutting the top side of the second block of pixels and the right side of the matching arrangement abutting the left side of the second block of pixels.

24. The method of claim 21, wherein the matching arrangement of pixels is further defined by each pixel of the matching arrangement of pixels having a spatially corresponding pixel in the prediction template and having a prediction value that matches exactly a prediction value of the spatially corresponding pixel in the prediction template.

25. The method of claim 21, wherein the matching arrangement of pixels is further defined by each pixel of the matching arrangement of pixels having a spatially corresponding pixel in the prediction template and having a prediction value that matches a prediction value of the spatially corresponding pixel in the prediction template within a predefined tolerance threshold.

26. The method of claim 21, wherein identifying the matching arrangement of pixels within the processed region of pixels further comprises:
selecting a search region in the processed region of pixels;
selecting an anchor pixel of the prediction template, the anchor pixel having a first spatial position within the first spatial configuration;
for each respective pixel in the search region of pixels:
generating a test template in the search region having the first spatial configuration, wherein the respective pixel is at the first spatial position within the first spatial configuration of the test template;
determining if prediction values associated with pixel of the test template match prediction values associated with the prediction template;
in response to determining that the prediction values associated with the test template match the prediction values associated with the prediction template, identifying the test template as a potential match for the matching arrangement of pixels.

27. The method of claim 26, wherein determining if the prediction values associated with pixels of the test template match the prediction values associated with pixels of the prediction template, includes:
determining if there is an exact match between the prediction values associated with pixels of the test template match the prediction values associated with pixels of the prediction template.

28. The method of claim 26, wherein determining if the prediction values associated with pixels of the test template match the prediction values associated with pixels of the prediction template, includes:
determining if the prediction values associated with pixels of the test template are within a predefined tolerance level the prediction values associated with pixels of the prediction template.

29. The method of claim 26, further comprising:
determining if multiple test templates are identified as a potential match for the matching arrangement of pixels;
in response to multiple test templates being identified as a potential match, selecting a best match test template as the matching arrangement of pixels.

30. A computing device, comprising:
a memory that stores computer instructions; and
a processor that executes the computer instructions to:
obtain a video frame that includes an array of pixels, the array of pixels including a processed region of pixels and an unprocessed region of pixels, the processed region of pixels having prediction values associated therewith and the unprocessed region not having prediction values associated therewith,
obtain a first block of pixels of the unprocessed region of pixels, the first block of pixels having a first width and a first height;
select a prediction template from the processed region of pixels, the prediction template includes a first plurality of pixels in a first spatial configuration and being in a first position relative to the first block of pixels;
identify a matching arrangement of pixels within the processed region of pixels that matches the prediction template, wherein the matching arrangement of pixels includes a second plurality of pixels in the first spatial configuration and being in the first position relative to a second block of pixels, the second block of pixels having the first width and the first height; and
associate prediction values with the first block of pixels by, for each respective pixel of the first block of pixels:
identify a pixel of the second block of pixels that spatially corresponds to the respective pixel of the first block of pixels; and
map a prediction value associated with the corresponding pixel in the second block of pixels to the respective pixel of the first block of pixels.

31. The computing device of claim 30, wherein the processor identifies the matching arrangement of pixels within the processed region of pixels by executing further actions to:
identify the matching arrangement of pixels in response to each pixel of the matching arrangement of pixels having a spatially corresponding pixel in the prediction template and having a prediction value that matches exactly a prediction value of the spatially corresponding pixel in the prediction template.

32. The computing device of claim 30, wherein the processor identifies the matching arrangement of pixels within the processed region of pixels by executing further actions to:
identify the matching arrangement of pixels in response to each pixel of the matching arrangement of pixels having a spatially corresponding pixel in the prediction template and having a prediction value that matches a prediction value of the spatially corresponding pixel in the prediction template within a predefined tolerance threshold.

33. The computing device of claim 30, wherein the processor identifies the matching arrangement of pixels within the processed region of pixels by executing further actions to:
select a search region in the processed region of pixels;
select an anchor pixel of the prediction template, the anchor pixel having a first spatial position within the first spatial configuration;
for each respective pixel in the search region of pixels:
generate a test template in the search region having the first spatial configuration, wherein the respective pixel is at the first spatial position within the first spatial configuration of the test template;
determine if prediction values associated with pixel of the test template match prediction values associated with the prediction template;
in response to determining that the prediction values associated with the test template match the prediction values associated with the prediction template, identifying the test template as a potential match for the matching arrangement of pixels.

34. The computing device of claim 33, wherein the processor determines if the prediction values associated with pixels of the test template match the prediction values associated with pixels of the prediction template by executing further actions to:
determine if there is an exact match between the prediction values associated with pixels of the test template match the prediction values associated with pixels of the prediction template.

35. The computing device of claim 33, wherein the processor determines if the prediction values associated with pixels of the test template match the prediction values associated with pixels of the prediction template by executing further actions to:
determine if the prediction values associated with pixels of the test template are within a predefined tolerance level the prediction values associated with pixels of the prediction template.
